(19) United States
(12) Patent Application Publication
(10) Pub. No.: US 2008/0057351 A1
(43) Pub. Date: Mar. 6, 2008

(54) Magnetic recording medium

(75) Inventors: Katsuhiko Meguro, Odawara-shi (JP); Masatoshi Takahashi, Odawara-shi (JP); Takeshi Harasawa, Odawara-shi (JP)

Correspondence Address: SUGHRUE-265550, 2100 PENNSYLVANIA AVE. NW, WASHINGTON, DC, 20037-3213, US

(73) Assignee: FUJIFILM Corporation, Minato-ku (JP)

(21) Appl. No.: 11/730,176

(22) Filed: Mar. 29, 2007

(30) Foreign Application Priority Data
Mar. 29, 2006 (JP) 2006-092181

(51) Int. Cl. G11B 5/738

(52) U.S. Cl. 428/840

(57) ABSTRACT

A magnetic recording medium, which comprises: a backcoat layer; a nonmagnetic support; a nonmagnetic layer; and a magnetic layer, in this order, wherein the backcoat layer has Tg of from 65 to 95° C., and the binder constituting the backcoat layer satisfies the following requirements: (1) the binder comprises a vinyl chloride-based resin (PVC) and a polyurethane resin (PU); (2) PVC has a solubility parameter of from 9 to 11 (cal·cm³)^{1/2}, Tg of from 65 to 95° C. and Mw of from 5000 to 25000; (3) a ratio of PVC to the total mass of PVC and PU is from 10 to 60% by mass; (4) PU has a solubility parameter of from 9.5 to 11.5 (cal·cm⁻³)^{1/2}, Tg of from 80 to 110° C. and Mw of from 20000 to 60000; and (5) a ratio of PU to the total mass of PVC and PU is from 90 to 30% by mass.

### BACKGROUND OF THE INVENTION

1. Field of the Invention

This invention relates to a magnetic recording medium. More specifically, it relates to a magnetic recording medium having excellent electromagnetic conversion characteristics, achieving a high running stability, maintaining a high S/N ratio, showing reduced dropout and having a low error rate.

2. Description of the Related Art

With the recent diffusion of personal computers, workstations and so on, studies have been vigorously made in the field of magnetic tapes on magnetic recording media as external storage devices for recording computer data. To use such a magnetic recording medium for the above purpose in practice, it is strongly required to enlarge the memory capacity so as to satisfy the requirements for high-capacity and downsized recording devices accompanying the downsizing and increasing in data processing ability of computers.

Recently, there have been proposed reproducing heads, the operation principle of which is based on magnetic resistance (MR), and utilized in hard disks and so on. JP-A-08-227517 proposes the application thereof to magnetic tapes. An MR head can provide a reproducing output higher by several times than an induction magnetic head, shows largely reduced instrumental noise such as impedance noise because of having no magnetic coil, thus causes large reduction in the noise of a magnetic recording medium, thereby achieving a high S/N ratio. In other words, reduction of magnetic recording medium noise, which has been shield by the instrumental noise, enables favorable record reproduction and contributes to remarkable improvement in the high-density recording characteristics.

As the existing magnetic recording media, use has been widely made of products having a magnetic layer, in which a powder of iron oxide, Co-modified iron oxide, CrO₂ or ferromagnetic hexagonal ferrite is dispersed in a binder, formed on a nonmagnetic support. In particular, it is known that magnetic powders such as a ferromagnetic hexagonal ferrite powder, a ferromagnetic metal powder and ferromagnetic iron nitride particles are excellent in high-density recording characteristics. To reduce the magnetic recording medium noise, it is effective to reduce the particle size of a ferromagnetic powder. In recent years, therefore, use has been made of magnetic materials comprising a ferromagnetic hexagonal ferrite micropowder having a tablet size of 50 nm or less, a ferromagnetic metal powder having an average major axis length of 100 nm or less and ferromagnetic iron nitride particles having an average particle diameter of 25 nm or less so that preferable effects are established.

To achieve a higher recording density and a larger recording capacity, there is a trend toward a narrower track width in recording and reproducing performance of a magnetic recording medium. In the field of magnetic tapes, furthermore, attempts have been made to reduce the thickness of a magnetic tape so as to conduct high-density recording. Thus, a large number of magnetic tapes having a total thickness of 10 μm or less have been already marketed. As the reduction in the thickness, however, a magnetic recording medium is liable to be largely affected by temperature and humidity during preservation and running, changes in tension and so on.

In the recording/reproducing performance of a magnetic recording/reproducing system with the use of the linear recording system, a magnetic head moves in the width direction of a magnetic tape and select one track. With the reduction in the track width, a higher accuracy is required in controlling the relating positions of the magnetic tape and the head. Although the S/N ratio can be elevated and the track width can be narrowed by using such an RM head and magnetic microparticles as described above, it is sometimes observed that a magnetic recording medium is deformed due to changes in the temperature or humidity in the working environment or tension changes in the drive and thus the recorded track cannot be read by the reproducing head. Thus, the medium should also have an elevated dimensional stability compared with the existing media. To maintain stable recording and reproducing, such a high-density magnetic recording medium should be superior in dimensional stability and mechanical strength to the existing ones.

To lessen effects of temperature/humidity or tension in the drive, there has been proposed to optimize the strength of a support or to elevate the glass transition temperature of a coating layer such as a magnetic layer, a nonmagnetic layer or a backcoat layer in the case of a magnetic recording medium of the coating type (see, for example, JP-A-2005-18821). However, it is found out that, when the glass transition temperature is excessively elevated, however, there arise some problems such that the cut edge cracks in cutting the tape and a coating film peels off from the tape during running and transfers to the magnetic layer or sticks to the reproducing head or the running system to thereby cause signal loss.

Moreover, there has been also proposed a magnetic recording medium in which the glass transition temperature of the backcoat layer is controlled to 30 to 60° C. (JP-A-10-334453). When this magnetic recording medium is wound as a tape, there arises a problem that the magnetic layer sticks to the backcoat layer.

### SUMMARY OF THE INVENTION

Accordingly, it is an object of the present invention to provide a magnetic recording medium which is scarcely affected by temperature/humidity or tension in the drive, is excellent in dimensional stability and mechanical strength, has excellent electromagnetic conversion characteristics, achieves a high running stability, maintains a high S/N ratio, shows reduced dropout and has a low error rate.

To solve the problems as described above, the inventors conducted intensive studies particularly on the physical properties of a backcoat layer of a magnetic recording medium which has a nonmagnetic layer containing a nonmagnetic powder and a binder and a magnetic layer containing a ferromagnetic powder and a binder in this order on one face of a nonmagnetic support, and the backcoat layer formed on the other face of the nonmagnetic support. As a result, they have found out that the above-described problems can be solved by specifying the glass transition temperature of the backcoat layer and the kind and the physical properties of the binder, thereby completing the invention.

Accordingly, the present invention is as follows.

[1] A magnetic recording medium, which comprises:

a backcoat layer comprising a first binder;

a nonmagnetic support;

a nonmagnetic layer comprising a nonmagnetic powder and a second binder; and

a magnetic layer comprising a ferromagnetic powder and a third binder, in this order,

wherein the backcoat layer has a glass transition temperature of from 65 to 95° C., and

the first binder satisfies all of the following requirements (1) to (5):

(1) the first binder comprises a vinyl chloride-based resin and a polyurethane resin as main components;

(2) the vinyl chloride-based resin has a solubility parameter of from 9 to 11 (cal·cm⁻³)^{1/2}, a glass transition temperature of from 65 to 95° C. and a weight-average molecular weight of from 5000 to 25000;

(3) a ratio of the vinyl chloride-based resin to the total mass of the vinyl chloride-based resin and the polyurethane resin is from 10 to 60% by mass;

(4) the polyurethane resin has a solubility parameter of from 9.5 to 11.5 (cal·cm⁻³)^{1/2}, a glass transition temperature of from 80 to 110° C. and a weight-average molecular weight of from 20000 to 60000; and

(5) a ratio of the polyurethane resin to the total mass of the vinyl chloride-based resin and the polyurethane resin is from 90 to 30% by mass.

[2] The magnetic recording medium as described in [1] above,

wherein the ferromagnetic powder is a ferromagnetic hexagonal ferrite powder having an average tabular diameter of from 10 to 50 nm, an iron nitride powder having an average particle diameter of from 5 to 25 nm or a ferromagnetic metal powder having an average major axis length of from 10 to 100 nm.

[3] The magnetic recording medium as described in [1] or [2] above,

wherein the backcoat layer further comprises at least one of a carbon black and an inorganic powder.

[4] The magnetic recording medium as described in any of [1] to [3] above,

wherein the backcoat layer has a thickness of from 0.1 to 1.0 μm.

[5] The magnetic recording medium as described in any of [1] to [4] above,

wherein the backcoat layer has a glass transition temperature of from 70 to 90° C.

[6] The magnetic recording medium as described in any of [1] to [5] above,

wherein the vinyl chloride-based resin has a solubility parameter of from 9.5 to 10.5 (cal·cm⁻³)^{1/2}.

[7] The magnetic recording medium as described in any of [1] to [6] above,

wherein the vinyl chloride-based resin has a glass transition temperature of from 70 to 90° C.

[8] The magnetic recording medium as described in any of [1] to [7] above,

wherein the vinyl chloride-based resin has a weight-average molecular weight of from 10000 to 20000.

[9] The magnetic recording medium as described in any of [1] to [8] above,

wherein the polyurethane resin has a solubility parameter of from 10.0 to 11.0 (cal·cm⁻³)^{1/2}.

[10] The magnetic recording medium as described in any of [1] to [9] above,

wherein the polyurethane resin has a glass transition temperature of from 80 to 95° C.

[11] The magnetic recording medium as described in any of [1] to [10] above,

wherein the vinyl chloride-based resin contains at least one of: from 2 to 7 eq/ton of at least one polar group selected from the group consisting of —SO₃M, —OSO₃M, —PO(OM)₂, —OPO(OM)₂ and —COOM, wherein M represents a hydrogen atom, an alkaline metal or an ammonium salt; and from 5 to 50 eq/ton of at least one polar group selected from the group consisting of —CONR₁R₂, —NR₁R₂ and —NR₁R₂R₃⁺, wherein R₁, R₂ and R₃ each independently represents a hydrogen atom or an alkyl group.

[12] The magnetic recording medium as described in any of [1] to [1,1] above,

wherein the polyurethane resin contains at least one of: from 2 to 7 eq/ton of at least one polar group selected from the group consisting of —SO₃M, —OSO₃M, —PO(OM)₂, —OPO(OM)₂ and —COOM, wherein M represents a hydrogen atom, an alkaline metal or an ammonium salt; and from 5 to 50 eq/ton of at least one polar group selected from the group consisting of —CONR₁R₂, —NR₁R₂ and —NR₁R₂R₃⁺, wherein R₁, R₂ and R₃ each independently represents a hydrogen atom or an alkyl group.

[1,3] The magnetic recording medium as described in any of [1] to [1,2] above,

wherein the polyurethane resin contains 2 to 40 OH— groups per molecule.

### DETAILED DESCRIPTION OF THE INVENTION

Now, the invention will be described in greater detail.

[Nonmagnetic Support]

As the nonmagnetic support to be used in the invention, use can be made of a publicly known film made of, for example, a polyester such as polyethylene terephthalate or polyethylene naphthalate, a polyolefin, cellulose triacetate, polycarbonate, polyamide, polyimide, polyamideimide, polysulfone, polyaramide, an aromatic polyamide or polybenzoxazole. It is preferable to use a support having a high strength such as polyethylene naphthalate or polyamide. If required, it is also possible to use a layered support as disclosed by JP-A-3-224127 to thereby differentiate the surface roughnesses of the magnetic face and the nonmagnetic support face. Such a support may be subjected to a pretreatment such as corona discharge, plasma treatment, adhesion facilitation, heating or dedusting. It is also possible to use an aluminum or glass plate as the support of the invention.

Among all, a polyester support (hereinafter called merely polyester) is preferred. This is a polyester made up of a dicarboxylic acid and a diol such as polyethylene terephthalate or polyethylene naphthalate.

Examples of the dicarboxylic acid component serving as a main constituent include terephthalic acid, isophthalic acid, phthalic acid, 2,6-naphthalenedicarboxylic acid, 2,7-naphthalene dicarboxylic acid, diphenylsulfone dicarboxylic acid, diphenyl ether dicarboxylic acid, diphenylethane dicarboxylic acid, cyclohexane dicarboxylic acid, diphenyl dicarboxylic acid, diphenyl thioether dicarboxylic acid, diphenyl ketone dicarboxylic acid, phenylindane dicarboxylic acid and so on.

Examples of the diol component include ethylene glycol, propylene glycol, tetramethylene glycol, cyclohexane dimethanol, 2,2-bis(4-hydroxyphenyl)propane, 2,2-bis(4-hydroxyethoxyphenyl)propane, bis(4-hydroxyphenyl)sulfone, bisphenolfluorene dihydroxyethyl ether, diethylene glycol, neopentyl glycol, hydroquinone, cyclohexanediol and so on.

Among polyesters comprising these components as the main constituents, polyesters comprising, as the main constituents, terephthalic acid and/or 2,6-naphthalene dicarboxylic acid as the dicarboxylic acid component and ethylene glycol and/or 1,4-cyclohexane dimethanol as the diol component are preferable from the viewpoints of transparency, mechanical strength, dimensional stability and so on.

In particular, a polyester comprising polyethylene terephthalate or polyethylene-2,6-naphthalate as the main constituent, a copolymer polyester comprising terephthalic acid, 2,6-naphthalene dicarboxylic acid and ethylene glycol and a polyester comprising a mixture of two or more types of these polyesters as the main constituents are preferable. A polyester comprising polyethylene-2,6-naphthalate as the main constituent is particularly preferable.

The polyester to be used in the invention may be a biaxially stretched polyester or a laminate having two or more layers.

The polyester may be a copolymer having an additional copolymerizable component or a mixture having another polyester. As examples thereof, the dicarboxylic acid components and the diol components described above and polyesters comprising the same can be cited.

To minimize delamination in film, it is possible in the polyester to be used in the invention to copolymerize an aromatic dicarboxylic acid having a sulfonate group or an ester-forming derivative thereof, a dicarboxylic acid having a polyoxyalkylene group or an ester-forming derivative thereof, a diol having a polyoxyalkylene group, etc.

Considering the polymerization reactivity of the polyester and the transparency of the film, it is particularly preferable to use 5-sodium sulfoisophthalate, 2-sodium sulfoterephthalate, 4-sodium sulfophthalate, 4-sodium sulfo-2,6-naphthalenedicarboxylate, compounds wherein sodium in the above compounds are substituted by other metals (for example, potassium or lithium), an ammonium salt, a phosphonium salt or the like or ester-forming derivatives thereof, polyethylene glycol, polytetramethylene glycol, polyethylene glycol-polypropylene glycol copolymer and compounds wherein the hydroxyl groups at both ends of the above compounds are oxidized into carboxyl groups. To copolymerize for this purpose, it is preferable to use such a compound in an amount of from 0.1 to 10% by mol based on the dicarboxylic acid constituting the polyester.

In order to improve heat resistance, it is possible to copolymerize a bisphenol compound or a compound having a naphthalene ring or a cyclohexane ring. Such a compound is preferably copolymerized in an amount of from 1 to 20% by mol based on the dicarboxylic acid constituting the polyester.

In the invention, the polyester can be synthesized in accordance with a publicly known method of producing a polyester without particular restriction. For example, use can be made of the direct esterification method which comprises subjecting the dicarboxylic acid component and the diol component directly to an esterification reaction, or the transesterification method which comprises first subjecting to a dialkyl ester employed as the dicarboxylic acid component and the diol component to a transesterification reaction, then heating the reaction mixture under reduced pressure and thus removing the excessive diol component to thereby conduct polymerization. In this step, a transesterification catalyst or a polymerization may be used or a heat resistance stabilizer may be added, if needed.

Moreover, it is possible to add one or more additives selected from among, for example, a coloring inhibitor, an antioxidant, a crystal nucleating agent, a slippering agent, a stabilizer, an antiblocking agent, an ultraviolet light absorber, a viscosity-controlling agent, a defoaming/clarifying agent, an antistatic agent, a pH adjusting agent, a dye, a pigment and a reaction-terminating agent in any step during the synthesis.

It is also possible to add a filler to the polyester. Examples of the filler include inorganic powders such as spherical silica, colloidal silica, titanium oxide and alumina and organic fillers such as crosslinked polystyrene and a silicone resin.

It is also possible to elevate the rigidity of the support by superstretching the material or forming a layer of a metal, a half metal or an oxide thereof on the surface of the support.

It is preferable that the thickness of the polyester to be used as the nonmagnetic support in the invention is from 3 to 80 μm, more preferably from 3 to 50 μm and particularly preferably from 3 to 10 μm. It is also preferable that the average surface roughness (Ra) at the center of the support surface is 6 nm or less, more preferably 4 nm or less. This Ra is measured by using a surface roughness meter (HD2000; manufactured by WYKO Co.).

The lengthwise and widthwise Young's modules of the nonmagnetic support are preferably 6.0 GPa or above and more preferably 7.0 GPa or above.

In the magnetic recording medium of the invention, a magnetic layer containing a ferromagnetic powder and a binder is formed at least one face of the nonmagnetic support as described above. It is preferable that a nonmagnetic layer (an under layer), which is substantially nonmagnetic, is formed between the nonmagnetic support and the magnetic layer.

[Magnetic Layer]

It is preferable that the volume of the ferromagnetic powder contained in the magnetic layer is from 1000 to 20000 nm³, more preferably from 2000 to 8000 nm³. By controlling the volume within the range as specified above, worsening in the magnetic characteristics caused by heat fluctuation can be effectively prevented and, at the same time, a favorable C/N (S/N) can be obtained while sustaining low noise. As the ferromagnetic powder, it is preferable to use a ferromagnetic metal powder, a hexagonal ferrite powder or an iron nitride-based powder, though the invention is not restricted thereto.

The volume of an acicular powder is determined from the major axis length and the minor axis length on the assumption that the particles are column-shaped.

The volume of a tabular powder is determined from the tabular diameter and the axis length (tabular thickness) on the assumption that the particles are square column-shaped (hexagonal-shaped in the case of a hexagonal ferrite powder).

In the case of an iron nitride-based powder, the volume is determined on the assumption that the particles are spherical.

The size of a magnetic material is determined as follows. First, a portion of an appropriate amount of the magnetic layer is stripped off. To 30 to 70 mg of the magnetic layer thus stripped, n-butylamine is added and the mixture is sealed in a glass tube. Then, it is put in a heat decomposition apparatus and heated therein for about one day at 140° C. After cooling, the contents are taken out from the glass tube and divided into a liquid and a solid by centrifugation. The solid thus separated is washed with acetone to give a powdery sample for TEM. This sample is photographed under a scanning transmission electron microscope (H-9000; manufactured by Hitachi, Co.) at 100000× magnification. Then, it is printed on a photographic paper sheet at a total magnification ratio of 500000 to give a photograph of particles. In this photograph, the target magnetic material is selected and the outline of the particle is traced with a digitizer. Thus, 500 particles are measured with the use of an image analysis software (KS-400; manufactured by Carl Zeiss) and the average is calculated, thereby giving the average size.

<Ferromagnetic Metal Powder>

Although the ferromagnetic metal powder to be used in the magnetic layer of the magnetic recording medium of the invention is not particularly restricted so long as it contains Fe (including its alloy) as the main component, a ferromagnetic alloy powder containing α-Fe as the main component is preferable. In addition to the atom as specified above, this ferromagnetic powder may contain other atom(s) such as Al, Si, S, Sc, Ca, Ti, V, Cr, Cu, Y, Mo, Rh, Pd, Ag, Sn, Sb, Te, Ba, Ta, W, Re, Au, Hg, Pb, Bi, La, Ce, Pr, Nd, P, Co, Mn, Zn, Ni, Sr or B. It is preferable that it contains at least one of Al, Si, Ca, Y, Ba, La, Nd, Co, Ni and B (more preferably, C, Al and/or Y) in addition to α-Fe. More specifically speaking, it is preferable that Co, Al and Y are contained respectively from 10 to 40% by atom, from 2 to 20% by atom and from 1 to 15% by atom each based on Fe.

The ferromagnetic metal powder may be treated before the dispersion by using a dispersant, a lubricant, a surfactant or an antistatic agent as will be described hereinafter. Moreover, the ferromagnetic metal powder may contain water, a hydroxide or an oxide in a small amount. It is preferable that the water content of the ferromagnetic metal powder is controlled to 0.01 to 2%. It is preferable to optimize the water content of the ferromagnetic metal powder depending on the kind of the binder. It is preferable that the pH value of the ferromagnetic metal powder is optimized depending on the combination with the binder to be used. Namely, the pH value thereof usually ranges from 6 to 12, preferably from 7 to 11. The ferromagnetic metal powder sometimes contain a soluble inorganic ion such as Na, Ca, Fe, Ni, Sr, NH₄, SO₄, Cl, NO₂ or NO₃, though it is essentially preferable that the ferromagnetic metal powder is free from any of them. However, the characteristics are never affected so long as the total amount of these ions is not more than about 300 ppm. In the ferromagnetic metal powder to be used in the invention, a lower porosity is preferred. Thus, the porosity thereof is preferably 20% by volume or less, more preferably 5% by volume or less.

The average major axis length of the ferromagnetic metal powder is preferably from 10 to 100 nm, more preferably from 20 to 70 nm and particularly preferably from 30 to 60 nm.

The crystallite size of the ferromagnetic metal powder is from 70 to 180 angst, more preferably from 80 to 140 angst and more preferably from 90 to 130 angst.

This crystallite size is the average determined from the half width of diffraction peak by the Scherrer method with the use of an X-ray diffractometer (RINT 2000 SERIES; manufactured by Rigaku Ltd.) using an X-ray source CuKα1, a tube voltage 50 kV and a tube current 300 mA.

The specific surface area by the BET method (S_{BET}) of the ferromagnetic metal powder is preferably 45 to 120 m²/g, more preferably from 50 to 100 m²/g.

In the case where the S_{BET} is less than 45 m²/g, noise is elevated. It is undesirable that S_{BET} exceeds 120 m²/g, since favorable surface characteristics can be hardly obtained in this case. So long as S_{BET} falls within the range as defined above, both of favorable surface characteristics and low noise can be established. It is preferable to control the water content of the ferromagnetic metal powder to 0.01 to 2%.

It is preferable to optimize the water content of the ferromagnetic metal powder depending on the kind of the binder. It is preferable to optimize the pH value of the ferromagnetic metal powder depending on the kind of the binder and it ranges from 4 to 12, preferably from 6 to 10.

If necessary, the ferromagnetic powder may be made into Al, Si, P or an oxide thereof by surface-treating. The amount thereof is from 0.1 to 10% based on the ferromagnetic powder. It is preferable to conduct the surface treatment, since the adsorption of a lubricant such as a fatty acid can be thus regulated to 100 mg/m² or less.

The ferromagnetic metal powder sometimes contain a soluble inorganic ion such as Na, Ca, Fe, Ni or Sr, though the characteristics are never affected so long as the total amount of these ions is not more than about 200 ppm. In the ferromagnetic metal powder to be used in the invention, a lower porosity is preferred. Thus, the porosity thereof is preferably 20% by volume or less, more preferably 5% by volume or less.

Concerning the shape of the ferromagnetic metal powder, it may be either acicula-shaped, grain-shaped, rice grain-shaped or tablet-shaped, so long as the particle volume fulfills the requirement as described above. It is particularly preferable to use a ferromagnetic powder of the acicular type. In the case of the acicula-shaped ferromagnetic metal powder, the acicular ratio is preferably from 4 to 12, more preferably from 5 to 8. The antimagnetic force (Hc) of the ferromagnetic metal powder is preferably from 159.2 to 278.5 kA/m (from 2000 to 3500 Oe), more preferably from 167.1 to 238.7 kA/m (from 2100 to 3000 Oe). The saturation magnetic flux density thereof is preferably from 150 to 300 mT (from 1500 to 3000 G), more preferably from 160 to 290 mT. The saturation magnetization (σs) thereof is preferably from 90 to 140 A m²/kg (from 90 to 140 emu/g), more preferably from 100 to 120 A m²/kg. A smaller SFD (switching field distribution) of the magnetic material per se is preferred. An SFD of 0.6 or less is suitable for high-density digital magnetic recording, since favorable electromagnetic conversion characteristics and a high output can be obtained and sharp magnetic inversion and a small peak shift can be established in this case. To narrow the Hc distribution in the ferromagnetic metal powder, there have been proposed methods of improving geothite particle size distribution, using monodispersion αFe₂O₃, preventing interparticle sintering and so on.

As the ferromagnetic metal powder, use can be made of a product obtained by a publicly known method. Examples of such a method include a method in which moisture-containing iron oxide or iron oxide having been treated with an antisintering agent is reduced by using a reductive gas to give Fe or Fe—Co particles, a method in which reduction is conducted with the use of a complex organic acid salt (mainly an oxalic acid salt) and a reductive gas such as hydrogen, a method in which a metal carbonyl compound is thermally decomposed, a method in which an aqueous solution of a ferromagnetic metal is reduced by adding an reducing agent such as sodium borohydride, a hypophosphorous salt or hydrazine, a method in which a metal is vaporized in an inert gas under a low pressure to thereby give a powder, and so on. The ferromagnetic metal powder thus obtained is subjected to a publicly known deacidification treatment. It is preferable to employ a method comprising reducing moisture-containing iron oxide or iron oxide by using a reductive gas such as hydrogen and forming an oxide film on the surface while controlling the partial pressures of an oxygen-containing gas and an inert gas, temperature and reaction time, since only small magnetic loss arises in this case.

<Ferromagnetic Hexagonal Ferrite Powder>

Examples of the ferromagnetic hexagonal ferrite powder include substituted barium ferrite, substituted strontium ferrite, substituted lead ferrite and substituted calcium ferrite each optionally, cobalt-substituted and so on. More specifically speaking, examples thereof include magnetoplanbite type barium ferrite, magnetoplanbite type strontium ferrite, and magnetoplanbite type barium and strontium ferrites partially comprising a spinel phase. In addition to the predetermined atoms, the ferromagnetic hexagonal ferrite powder may contain Al, Si, S, Sc, Ca, Ti, V, Cr, Cu, Y, Mo, Rh, Pd, Ag, Sn, Sb, Te, Ba, Ta, W, Re, Au, Hg, Pb, Bi, La, Ce, Pr, Nd, P, Co, Mn, Zn, Ni, Sr, B, Ge, Nb, etc. In general, use can be made of a ferromagnetic hexagonal ferrite powder comprising elements such as Co—Zn, Co—Ti, Co—Ti—Zr, Co—Ti—Zn, Ni—Ti—Zn, Nb—Zn—Co, Sb—Zn—Co, Nb—Zn and so on. Moreover, the ferromagnetic hexagonal ferrite powder may contain impurities inherent to the material and/or production method employed. Preferable examples of the additional atoms and the amount thereof are the same as in the ferromagnetic metal powder as described above.

It is preferable that the hexagonal ferrite powder has such a particle size as satisfying the above requirement for the volume. The average tabular diameter thereof is from 10 to 50 nm, more preferably from 15 to 40 nm and more preferably from 20 to 30 nm.

The average tabular ratio (tabular diameter/tabular thickness) thereof ranges from 1 to 15, preferably from 1 to 7. So long as the tabular ratio falls within the range of from 1 to 15, a sufficient orientation can be achieved while sustaining high filling properties in the magnetic layer and an increase in noise caused by interparticle stacking can be prevented. The specific surface area determined by the BET method (S_{BET}) within the particle size range as described above is preferably 40 m²/g or more, more preferably from 40 to 200 m²/g and most preferably from 60 to 100 m²/g.

In usual, a narrower tabular diameter and tabular thickness distribution of the hexagonal ferrite powder is preferred. The tabular diameter and the tabular thickness can be numerically quantified by measuring 500 particles selected at random in a TEM photograph of the particles and comparing the data. Although the tabular diameter and tabular thickness distribution is not in normal distribution in many cases, the standard deviation calculated on the basis of the mean (σ/mean) is from 0.1 to 1.0. Attempts are made to sharpen the particle size distribution by homogenizing the particle formation system as far as possible and treating the thus formed particles to thereby improve the distribution. For example, there is known a method of selectively dissolving ultrafine particles in an acid solution.

The antimagnetic force (Hc) of the hexagonal ferrite powder may be adjusted to from 143.3 to 318.5 kA/m (from 1800 to 4000 Oe), preferably from 159.2 to 238.9 kA/m (from 2000 to 3000 Oe) and more preferably from 191.0 to 214.9 kA/m (from 2200 to 2800 Oe).

The antimagnetic force (Hc) can be controlled depending on the particle size (tabular diameter and tabular thickness), the kind and the amount of the element contained therein, the substitution site of the element, the conditions for the particle formation reaction and so on.

The saturation magnetization (σs) of the hexagonal ferrite powder is from 30 to 80 A m²/kg (emu/g). Although a higher saturation magnetization (σs) is preferred, the saturation magnetization (σs) is liable to lower with a decrease in the particle size. It is well known that the saturation magnetization (σs) can be improved by blending magnetoplanbite ferrite with spinel ferrite or appropriately selecting the kind and the amount of the element contained therein. It is also possible to employ a W type hexagonal ferrite. In dispersing the magnetic material, it has been a practice to treat the surface of magnetic material particles with a substance compatible with the dispersion medium and the polymer. As the surface-treating agent, an inorganic compound or an organic compound may be used. Typical examples thereof include oxides and hydroxides of Si, Al, P, etc., various silane coupling agents and various titanium coupling agents. The surface-treating agent is added in an amount of from 0.1 to 10% by mass based on the mass of the magnetic material. (In this specification, mass ratio is equal to weight ratio.) Also the pH value of the magnetic material is an important factor in the dispersion. Although the optimum pH value is usually in a range of from about 4 to about 12 depending on the dispersion medium and the polymer, a pH value of from about 6 to about 11 is selected by taking the chemical stability and preservation properties of the medium into consideration. Furthermore, the moisture contained in the magnetic material affects the dispersion. The water content is usually from 0.01 to 2.0%, though there is the optimum value depending on the dispersion medium and the polymer.

Examples of the method for producing the hexagonal ferrite powder include: (1) the glass crystallization method which comprises mixing and melting barium oxide, iron oxide, a metal oxide for substituting iron, and a glass-forming substance such as boron oxide at such a ratio as giving the desired ferrite composition, then quenching the mixture to give an amorphous product, heating it again and then washing and grinding to thereby give a barium ferrite crystal powder; (2) the hydrothermal reaction method which comprises neutralizing a solution of barium ferrite composition metal salts with an alkali, removing by-products, heating the residue in a liquid phase at 100° C. or higher, and then washing, drying and grinding to thereby give a barium ferrite crystal powder; (3) the coprecipitation method which comprises neutralizing a solution of barium ferrite composition metal salts with an alkali, removing by-products, treating the residue at 1100° C. or lower, and then grinding to thereby give a barium ferrite crystal powder; and so on, though the invention is not restricted to any method. If required, the hexagonal ferrite powder may be surface-treated with Al, Si, P or an oxide thereof, etc. The amount of the surface-treating agent is from 0.1 to 10% based on the ferromagnetic powder. It is preferable to conduct the surface treatment, since the adsorption of a lubricant such as a fatty acid can be thus regulated to 100 mg/m² or less. The ferromagnetic powder sometimes contain soluble inorganic ions such as Na, Ca, Fe, Ni and Sr. Although it is essentially preferable that the ferromagnetic powder is free from such ions, the characteristics thereof are not affected where the content of these ions is not more than 200 ppm.

<Magnetic Iron Nitride Powder>

In the case where a layer is formed on the surface of Fe₁₆N₂ particles, the average particle diameter of the Fe₁₆N₂ phase in magnetic iron nitride particles means individual Fe₁₆N₂ particles per se excluding the layer.

Although the magnetic iron nitride particles contain at least the Fe₁₆N₂ phase, it is preferably free from any other iron nitride phase. This is because the magnetic anisotropy of nitride crystals (Fe₄N or Fe₃N phase) is about 1×10⁵ erg/cc, while the Fe₁₆N₂ phase has a high crystal magnetic anisotropy of 2 to 7×10⁶ erg/cc. Owing to this characteristic, the Fe₁₆N₂ phase can sustain a high magnetic force even in the state of microparticles. This high crystal magnetic anisotropy can be established due to the crystalline structure of the Fe₁₆N₂ phase. namely, Fe₁₆N₂ crystals have a body-centered cubic structure wherein N atoms are regularly incorporated into the octahedral lattices of Fe. It is considered that the strain arising at the incorporation of the N atoms into the lattices would result in the high crystal magnetic anisotropy. The magnetization easy axis of the Fe₁₆N₂ phase is the C axis extended by nitriding.

It is preferable that the particles having the Fe₁₆N₂ phase are grain-shaped or ellipse-shaped and spherical particles are more preferable. Acicular particles are undesirable, since one of the three equivalent directions of an α-Fe cubic crystal is selected by nitriding and serves as the C axis (i.e., the magnetization easy axis) and, therefore, acicula-shaped particles involve both of particles having the major axis as the magnetization easy axis and particles having the minor axis as magnetization easy axis. Accordingly, the average axis ratio (major axis length/minor axis length) is preferably 2 or less (for example, from 1 to 2), more preferably 1.5 or less (for example, from 1 to 1.5).

The particle diameter is determined based on the particle diameter of iron particles before nitriding. A monodispersion is preferred, since a monodispersion generally suffers from lower medium noise. The particle diameter of a magnetic iron nitride-based powder having Fe₁₆N₂ as the main phase is determined based on the diameter of iron particles. It is preferable that the particle diameter of the iron particles is a monodispersion. This is because the extent of nitriding differs between large particles and small particles and thus magnetic characteristics are also different. From this point of view, it is also preferred that the particle diameter dispersion of the magnetic iron nitride-based powder is a monodispersion.

The particle diameter of the Fe₁₆N₂ phase, which is a magnetic material, is from 9 to 11 nm. At a smaller particle diameter, there arises a serious effect of heat fluctuation and the magnetic material becomes superparamagnetic, which makes it unsuitable for a magnetic recording medium. In this case, furthermore, the magnetic coercive force is elevated due to magnetic viscosity in high-speed recording at a head, which makes recording difficult. At a larger particle diameter, on the other hand, saturation magnetization cannot be lessened and thus the magnetic coercive force in recording is elevated, which also makes the recording difficult. Furthermore, a larger particle diameter results in an increase in the particle noise in the magnetic recording medium produced therefrom. It is preferable that the particle diameter dispersion is a monodispersion, since a monodispersion generally suffers from lower medium noise. The coefficient of variation in the particle diameter is 15% or less (preferably from 2 to 15%), more preferably 10% or less (preferably from 2 to 10%).

It is preferable that the surface of the magnetic iron nitride-based powder having Fe₁₆N₂ as the main phase is coated with an oxide film, since Fe₁₆N₂ microparticles are liable to be oxidized and, therefore, should be handled in a nitrogen atmosphere.

It is preferable that the oxide film contains an element selected from among rare earth elements and/or silicon and aluminum. Thus, the magnetic iron nitride-based powder has similar particle surface as the existing so-called metal particles comprising iron and Co as the main components and, therefore, becomes highly compatible with the steps of handling these metal particles. As the rare earth element, use may be preferably made of Y, La, Ce, Pr, Nd, Sm, Tb, Dy and Gd. From the viewpoint of dispersibility, Y is particularly preferred.

In addition to silicon and aluminum, the magnetic iron nitride-based powder may further contain boron or phosphorus if needed. Furthermore, it may contain, as an effective element, carbon, calcium, magnesium, zirconium, barium, strontium and so on. By using such an element together with the rare earth elements and/or silicon and aluminum, the shape-retention properties and the dispersion performance can be improved.

In the composition of the surface compound layer, the total amount of rare earth elements, boron, silicon, aluminum and phosphorus is preferably from 0.1 to 40.0% by atom, more preferably from 1.0 to 30.0% by atom and more preferably from 3.0 to 25.0% by atom based on iron. In the case where these elements are contained in an excessively small amount, the surface compound layer can be hardly formed and thus the magnetic anisotropy of the magnetic powder is lowered and the oxidation stability thereof is worsened. In the case there these elements are contained too much, the saturation magnetization is frequently lowered in excess.

The thickness of the oxide film preferably ranges from 1 to 5 nm, more preferably from 2 to 3 nm. When the thickness is smaller than the lower limit, the oxidation stability is frequently lowered. When it is larger than the upper limit, on the other hand, it is sometimes observed that the particle size can be hardly reduced in practice.

Concerning the magnetic characteristics of the iron nitride-based magnetic particles having Fe₁₆N₂ as the main phase, the magnetic coercive force (Hc) thereof is preferably from 79.6 to 318.4 kA/m (from 1,000 to 4,000 Oe), more preferably from 159.2 to 278.6 kA/m (from 2000 to 3500 Oe) and more preferably from 197.5 to 237 kA/m (from 2500 to 3000 Oe). This is because the effects by neighboring bits are enlarged at a lower Hc in in-plane recording, while recording becomes difficult in some cases at a higher Hc.

The saturation magnetization is preferably from 80 to 160 Am²/kg (from 80 to 160 emu/g), more preferably from 80 to 120 Am²/kg (from 80 to 120 emu/g). In the case where the saturation magnetization is too low, a signal becomes weak in some cases. When it is too high, on the other hand, the effects on neighboring bits are enlarged in, for example, in-plane recording and thus the medium becomes unsuitable for high-density recording. The squareness ratio preferably ranges from 0.6 to 0.9.

It is also preferable that the magnetic powder has a BET specific surface area of from 40 to 100 m²/g. In the case where the BET specific surface area is too small, the particle size becomes larger and thus serious particle noise arises in using a magnetic recording medium. In this case, moreover, the surface smoothness of the magnetic layer is worsened and thus the reproduction output is lowered in many cases. In the case where the BET specific surface area is too large, on the other hand, the particles having the Fe₁₆N₂ phase are liable to aggregate. As a result, it becomes difficult to obtain a homogeneous dispersion and, in its turn, a smooth surface can be hardly obtained.

As described above, the average particle diameter of the iron nitride-based powder is 30 nm or less, preferably from 5 to 25 nm and more preferably from 10 to 20 nm.

To produce the iron nitride-based particles, use can be made of publicly known techniques, for example, a method disclosed by WO 2003/079332.

The magnetic particles produced by the above-described method can be appropriately used in a magnetic layer of magnetic recording media. Examples of the magnetic recording media include magnetic tapes such as video tapes and computer tapes, magnetic disks such as Floppy® disks and hard disks and so on.

[Binder]

To a binder, a lubricant, a dispersant, an additive, a solvent, a dispersion method and so on to be used in the magnetic layer and the nonmagnetic layer of the magnetic recording medium according to the invention, publicly known techniques for magnetic layers and nonmagnetic layers can be applied. In particular, publicly known techniques relating to magnetic layers are applicable to the amount of a binder and the kind thereof, the amount of an additive or a dispersant to be added and the kind thereof.

Examples of the binder to be used in the invention include publicly known thermoplastic resins, thermosetting resins, reactive resins and mixture thereof. Examples of the thermoplastic resins include those having a glass transition temperature of −100° to 150° C., a number-average molecular weight of 1,000 to 200,000, preferably 10,000 to 100,000, and a polymerization degree of about 50 to about 1,000.

Examples of such thermoplastic resins include polymers or copolymers containing as constituent units vinyl chloride, vinyl acetate, vinyl alcohol, maleic acid, acrylic acid, acrylic ester, vinylidene chloride, acrylonitrile, methacrylic acid, methacrylic ester, styrene, butadiene, ethylene, vinyl butyral, vinyl acetal, vinyl ether, etc., polyurethane resins, and various rubber resins. Examples of the d thermosetting resins or reactive resins include phenol resin, epoxy resin, polyurethane hardening resin, urea resin, melamine resin, alkyd resin, acrylic reactive resin, formaldehyde resin, silicone resin, epoxy-polyamide resin, a mixture of polyester resin and isocyanate prepolymer, a mixture of polyester polyol and polyisocyanate, and a mixture of polyurethane and polyisocyanate. These resins are described in detail in Purasuchikku Handobukku, Asakura Shoten. Further, known electron radiation curing resins can be incorporated in the individual layers. Examples of these resins and methods of producing the same are described in detail in JP-A-62-256219. The above-described resins can be used either singly or in combination. Preferred examples of such a combination of resins include a combination of at least one selected from vinyl chloride resin, vinyl chloride-vinyl acetate copolymer, vinyl chloride-vinyl acetate-vinyl alcohol copolymer and vinyl chloride-vinyl acetate-maleic anhydride copolymer with a polyurethane resin, and a combination thereof with polyisocyanate.

Examples of the structure of polyurethane resins which can be used in the present invention include known structures such as polyester polyurethane, polyether polyurethane, polyether polyester polyurethane, polycarbonate polyurethane, polyester polycarbonate polyurethane and polycaprolactone polyurethane. To obtain better dispersibility and durability, it is preferable to select, from among the binders cited herein, those into which at least one polar group selected from —COOM, —SO₃ M, —OSO₃ M, —P═O(OM)₂, —O—P═O(OM)₂ (in which M represents a hydrogen atom or alkaline metal salt group), —OH, —NR², —N⁺R³ (in which R is a hydrocarbon group), epoxy group, —SH, —CN, and the like has been introduced by copolymerization or addition reaction. The amount of such a polar group is in the range of 10⁻¹ to 10⁻⁸ mol/g, preferably 10⁻² to 10⁻⁶ mol/g.

Specific examples of these binders used in the present invention include VAGH, VYHH, VMCH, VAGF, VAGD, VROH, VYES, VYNC, VMCC, XYHL, XYSC, PKHH, PKHJ, PKHC and PKFE (manufactured by Dow Chemical Co.), MPR-TA, MPR-TA5, MPR-TAL, MPR-TSN, MPR-TMF, MPR-TS, MPR-TM and MPR-TAO (manufactured by Nisshin Chemical Industry, Co., Ltd.), 1000W, DX80, DX81, DX82, DX83 and 100FD (manufactured by The Electro Chemical Industrial Co., Ltd.), MR-104, MR-105, MR110, MR100, MR555 and 400X-110A (manufactured by ZEON Corporation), Nippolan N2301, N2302 and N2304 (manufactured by Nippon Urethane), T-5105, T-R3080, T-5201, Barnok D-400 and D-210-80, and Crisbon 6109 and 7209 (manufactured by Dainippon Ink And Chemicals, Incorporated), Vylon UR8200, UR8300, UR-8700, RV530 and RV280 (manufactured Toyobo Co., Ltd.), Difelamine 4020, 5020, 5100, 5300, 9020, 9022 and 7020 (manufactured by Dainichi Seika K.K.), MX5004 (manufactured by Mitsubishi Chemical Industries Ltd.), Sanprene SP-150 (manufactured by Sanyo Kasei K.K.), and Salan F310 and F210 (manufactured by Asahi Chemical Industry Co., Ltd.).

The content of the binder to be contained in the nonmagnetic layer and the magnetic layer of the present invention is normally in the range of 5 to 50% by mass, preferably 10 to 30% by mass based on the nonmagnetic powder or the magnetic powder. In the case of using a vinyl chloride resin, its content is preferably in the range of 5 to 30% by mass. In the case of using a polyurethane resin, its content is preferably in the range of 2 to 20% by mass. In the case of using a polyisocyanate, its content is preferably in the range of 2 to 20% by mass. These binder resins are preferably used in these amounts in combination. In the case where head corrosion arises due to a small amount of dechlorination, it is also possible to use polyurethane alone or a combination of polyurethane with isocyanate. In the case of using polyurethane in the invention, its glass transition temperature ranges from −50° to 150° C., preferably from 0° C. to 100° C., its breaking extension preferably range from 100 to 2,000%, its breaking stress preferably ranges from 0.05 to 10 kg/mm² (0.49 to 98 MPa) and its yield point preferably ranges from 0.05 to 10 kg/mm² (0.49 to 98 MPa).

Examples of polyisocyanates which can be used in the present invention include isocyanates such as tolylene diisocyanate, 4-4′-diphenylmethane diisocyanate, hexamethylene diisocyanate, xylylene diisocyanate, naphthylene-1,5-diisocyanate, o-toluidine diisocyanate, isophorone diisocyanate and triphenylmethane triisocyanate, products of the reaction of these isocyanates with polyalcohols, and polyisocyanates produced by the condensation of isocyanates. Examples of the trade names of these commercially available isocyanates include Colonate L, Colonate HL, Colonate 2030, Colonate 2031, Millionate MR and Millionate MTL (manufactured by Nippon Polyurethane Industry Co., Ltd.), Takenate D-102, Takenate D-110N, Takenate D-200 and Takenate D-202 (manufactured by Takeda Chemical Industries, Ltd.), and Desmodur L, Desmodur IL, Desmodur N and Desmodur HL (manufactured by Sumitomo Bayer). These isocyanates may be used singly. Alternatively, by utilizing the difference in hardening reactivity, two or more of these isocyanates can be used in combination in both the individual layers.

The magnetic layer according to the invention may further contain additive(s), if needed. Examples of the additives include an abrasive, a lubricant, a dispersant/dispersion aid, a mildewproofing agent, an antistatic agent, an antioxidative agent, a solvent, carbon black and so on. As these examples, use can be made of, for example, molybdenum disulfide, tungsten disulfide, graphite, boron nitride, fluorinated graphite, silicone oil, silicone having a polar group, aliphatic acid-modified silicone, fluorine-containing silicone, fluorine-containing alcohol, fluorine-containing ester, polyolefin, polyglycol, polyphenyl ether, aromatic cycle-containing organic phosphonic groups such as phenylphosphonic acid, benzylphosphonic acid, phenethylphosphonic acid, α-methylbenzylphosphonic acid, 1-methyl-1-phenethylphosphonic acid, diphenylmethylphosphonic acid, biphenylphosphonic acid, benzylphenylphosphonic acid, α-cumylphosphonic acid, tolylphosphonic acid, xylylphosphonic acid, ethylphenylphosphonic acid, cumenylphosphonic acid, propylphenylphosphonic acid, butylphenylphosphonic acid, heptylphenylphosphonic acid, octylphenylphosphonic acid and nonylphenylphosphonic acid and alkali metal salts thereof, alkylphosphonic acids such as octylphosphonic acid, 2-ethylhexylphosphonic acid, isooctylphosphonic acid, isononylphosphonic acid, isodecylphosphonic acid, isoundecylphosphonic acid, isododecylphosphonic acid, isohexadecylphosphonic acid, isooctadecylphosphonic acid and isoeicosylphosphonic acid and alkali metal salts thereof, aromatic phosphoric acid esters such as phenyl phosphate, benzyl phosphate, phenethyl phosphate, α-methylbenzyl phosphate, 1-methyl-1-phenethyl phosphate, diphenylmethyl phosphate, biphenyl phosphate, benzylphenyl phosphate, α-cumyl phosphate, tolyl phosphate, xylyl phosphate, ethylphenyl phosphate, cumenyl phosphate, propylphenyl phosphate, butylphenyl phosphate, heptylphenyl phosphate, octylphenyl phosphate and nonylphenyl phosphate and alkali metal salts thereof, alkyl phosphoric acid esters such as octyl phosphate, 2-ethylhexyl phosphate, isooctyl phosphate, isononyl phosphate, isodecyl phosphate, isoundecyl phosphate, isododecyl phosphate, isohexadecyl phosphate, isooctadecyl phosphate and isoeicosyl phosphate and alkali metal salts thereof, alkyl sulfonates and alkali metal salts thereof, fluorinated alkyl sulfates and alkali metal salts thereof, monobasic fatty acids having from 10 to 24 carbon atoms (which may contain an unsaturated bond or may be branched) such as lauric acid, myristic acid, palmitic acid, stearic acid, behenic acid, butyl stearate, oleic acid, linoleic acid, linolenic acid, elaidic acid and erucic acid and alkali metal salts thereof, monofatty acid esters, difatty acid esters or trifatty acid esters of a monobasic aliphatic acid, which has 10 to 24 carbon atoms, may contain an unsaturated bond and may be branched, with one of a mono- to hexavalent alcohol, which has 2 to 22 carbon atoms, may contain an unsaturated bond and may be branched, an alkoxy alcohol or a monoalkyl ether of an alkylene oxide polymer, which has 12 to 22 carbon atoms, may contain an unsaturated bond and may be branched, such as butyl stearate, octyl stearate, amyl stearate, isooctyl stearate, octyl myristate, butyl laurate, butoxyethyl stearate, anhydro sorbitan monostearate, anhydro sorbitan tristearate and so on, fatty acid amides having 2 to 22 carbon atoms and aliphatic amines having 8 to 22 carbon atoms. In addition to the hydrocarbon groups cited above, use may be made of those having an alkyl group, an aryl group or an aralkyl group substituted by a group other than a hydrocarbon group, for example, a nitro group or a halogenated hydrocarbon such as F, Cl, Br, CF₃, CCl₃ or CBr₃.

Further, use can be made of nonionic surfactants based on, for example, as alkylene oxide, glycerin, glycidol and alkylphenolethylene oxide addition products; cationic surfactants such as cyclic amines, ester amides, quaternary ammonium salts, hydantoin derivatives, heterocyclic compounds, phosphoniums and sulfoniums; anionic surfactants containing acidic groups such as carboxylate, sulfonate and sulfuric ester; amphoteric surfactants such as amino acids, aminosulfonic acids, sulfuric or phosphoric esters of amino alcohols and alkylbetaines, etc. can be used. These surfactants are described in greater detail in Kaimen Kasseizai Binran, Sangyo Tosho K.K.

These lubricants, antistatic agents, etc. may not be necessarily 100% pure but may contain impurities such as an isomer, an unreacted material, a by-product, a decomposition product and an oxide. The content of these impurities is preferably 30% by mass or less, more preferably 10% by mass or less.

Specific examples of these additives include NAA-102, castor hardened aliphatic acid, NAA-42, Cation SA, Nymean L-201, Nonion E-208, Anon BF and Anon LG (manufactured by NOF Corporation), FAL-205 and FAL-123 (manufactured by TAKEMOTO OIL & FAT Co.), Enujelb OL (manufactured by New Japan Chemical Co., Ltd.), TA-3 (manufactured by The Shin-Etsu Chemical Industry Co., Ltd.), Amide P (manufactured by Lion), Duomine TDO (manufactured by The Lion Fat and Oil Co., Ltd.), BA-41G (manufactured by The Nisshin Oillio Group, Ltd.), Profan 2012E, New Pole PE61, Ionet MS-400 (manufactured by Sanyo Chemical Industries, Ltd.) and so on.

If necessary, a carbon black may be incorporated in the magnetic layer in the invention. Examples of the carbon black usable in the magnetic layer include furnace black for rubber, thermal black for rubber, acetylene black, and so on. The carbon black preferably has a specific surface area of 5 to 500 m²/g, a DBP oil absorption of 10 to 400 ml/100 g, a particle diameter of 5 to 300 nm, a pH value of 2 to 10, a water content of 0.1 to 10% and a tap density of 0.1 to 1 g/ml.

Specific examples of the carbon black employable in the present invention include BLACKPEARLS 2000, 1300, 1000, 900, 905, 800, 700 and VULCAN XC-72 (manufactured by Cabot Corp.), #80, #60, #55, #50 and #35 (manufactured by Asahi Carbon Co., Ltd.), #2400B, #2300, #900, #1000, #30, #40 and #10B (manufactured by Mitsubishi Chemical Corp.), CONDUCTEX SC, RAVEN 1500, 50, 40, 15 and RAVEN-MT-P (manufactured by Columbia Carbon Corp.), and Ketchen Black EC (manufactured by Ketchen Black International Co.). Such a carbon black may be surface-treated with a dispersant, grafted with a resin or partially graphtized before using. Before adding to a magnetic coating, the carbon black may be dispersed by using a binder. Either a single carbon black or a combination thereof may be used. In the case of using the carbon black, the amount thereof is preferably from 0.1 to 30% by mass based on the mass of the magnetic material. The carbon blacks have effects of, for example, preventing the magnetic layer from static electrification, lowering coefficient of friction, shading, and enhancing film strength. These effects vary from carbon black to carbon black. Accordingly, it is possible in the magnetic layer and the nonmagnetic layer of the invention to select these carbon blacks of appropriate kinds, amounts and combinations so as to establish the desired purpose depending on the properties as discussed above (i.e., particle size, oil absorption, electrical conductivity, pH, etc.). In other words, an optimum combination of carbon blacks should be selected for each layer. For the details of the carbon black employable in the present invention, reference can be made to Kabon Burakku Binrann, Carbon Black Kyokai.

[Abrasive]

As the abrasives to be used in the present invention, use can be made of α-alumina having a percent alpha conversion of 90% or higher, β-alumina, silicon carbide, chromium oxide, cerium oxide, α-iron oxide, corundum, artificial diamond, silicon nitride, silicon carbide, titanium carbide, titanium oxide, silicon dioxide and boron nitride. In general, known materials having a Mohs hardness of 6 or above can be used singly or in combination. Also, use may be made of a composite material made of these abrasives (abrasive surface-treated with another abrasive) therefor. These abrasives sometimes contain compounds or elements other than the main component but similar effects can be established so far as the content of the main component is not less than 90%. The particle size of these abrasives is preferably in the range of 0.01 to 2 μm. To enhance the electromagnetic conversion properties, a narrower particle size distribution is preferred. If necessary, a plurality of abrasives having different particle sizes may be used in combination to improve durability. Alternatively, a similar effect can be established by using a single abrasive having a wider particle diameter distribution. The tap density of these abrasives preferably ranges from 0.3 to 2 g/cc. The water content of these abrasives preferably ranges from 0.1 to 5%. The pH value of these abrasives preferably ranges from 2 to 11. The specific surface area of these abrasives preferably ranges from 1 to 30 m²/g. Although the abrasive to be used in the present invention may be in the form of aciculas, spheres, cubes or tablets, it is preferable to employ an abrasive having edges partially on the surface thereof so as to establish a high abrasion. Specific examples thereof include AKP-12, AKP-15, AKP-20, AKP-30, AKP-50, HIT-20, HIT-30, HIT-55, HIT-60, HIT-70, HIT-80 and HIT-100 (manufactured by Sumitomo Chemical Co., Ltd.), ERC-DBM, HP-DBM and HPS-DBM (manufactured by Reynolds International Inc.), WA10000 (manufactured by Fujimi Kenma K.K.), UB20 (manufactured by Uemura Kogyo K.K.), G-5, Chromex U2 and Chromex U1 (manufactured by Nippon Chemical Industrial Co., Ltd.), TF10 and TF140 (manufactured by Toda Kogyo Co., Ltd.), beta-Random and Ultrafine (manufactured by Ividen Co., Ltd.) and B-3 (manufactured by Showa Mining Co., Ltd.). These abrasives may be added to the nonmagnetic layer, if necessary. By adding such an abrasive to the nonmagnetic layer, it is possible to control the surface figure or prevent abrasives from protruding. Needless to say, the particle diameters and amounts of abrasives to be added to the magnetic layer and the nonmagnetic layer should be selected independently at optimal values.

As the organic solvent to be used in the invention, use can be made of publicly known ones. Examples of the organic solvents which can be used in the present invention include ketones such as acetone, methyl ethyl ketone, methyl isobutyl ketone, diisobutyl ketone, cyclohexanone, isophorone and tetrahydrofuran, alcohols such as methanol, ethanol, propanol, butanol, isobutyl alcohol, isopropyl alcohol and methyl cyclohexanol, esters such as methyl acetate, butyl acetate, isobutyl acetate, isopropyl acetate, ethyl lactate and glycol acetate, glycol ethers such as glycol dimethyl ether, glycol monoethyl ether and dioxane, aromatic hydrocarbons such as benzene, toluene, xylene, cresol and chlorobenzene, chlorinated hydrocarbons such as methylene chloride, ethylene chloride, carbon tetrachloride, chloroform, ethylene chlorohydrin and dichlorobenzene, N,N-dimethylformamide, and hexane. These organic solvents may be used in any proportions.

These organic solvents are not necessarily 100% pure and may contain impurities such as isomers, unreacted matters, side reaction products, decomposition products, oxides and water besides main components. The content of these impurities is preferably 30% or less, more preferably 10% or less. In the present invention, it is preferable that the same kind of organic solvents are used in the magnetic layer and the nonmagnetic layer, though the amounts thereof may be different. A solvent having a high surface tension (e.g., cyclohexanone, dioxane) may be used for the nonmagnetic layer to enhance the coating stability. Specifically, it is desirable that the arithmetic mean of the solvent composition for the upper layer is not smaller than that of the solvent composition for the nonmagnetic layer. In order to enhance the dispersibility, it is preferable to employ an organic solvent having a high polarity. It is preferable that, in the solvent composition, a solvent having a dielectric constant of 15 or higher is contained in an amount of 50% or more. The solubility parameter of these solvents is preferably from 8 to 11.

If necessary, the kinds and amounts of these dispersants, lubricants and surface active agents to be used in the present invention may be varied between the magnetic layer and the nonmagnetic layer as will be discussed hereinafter. For example, a dispersant would be bonded or adsorbed at a polar group. Thus, it is mainly adsorbed by or bonded to the surface of the ferromagnetic metal powder in the magnetic layer and to the surface of the nonmagnetic powder in the nonmagnetic layer via the polar group. It appears that an organophosphorus compound once adsorbed is hardly detached from the surface of a metal or a metal compound. In the invention, therefore, the ferromagnetic metal powder surface or the nonmagnetic powder surface is in the state of being coated with an alkyl group, an aromatic group, etc., which improves the affinity of the ferromagnetic metal powder or the nonmagnetic powder to a binder component. Moreover, the dispersion stability of the ferromagnetic metal powder or the nonmagnetic powder is improved thereby. On the other hand, a lubricant exists in the free state. Thus, it is possible to use fatty acids having different melting points in the nonmagnetic layer and the magnetic layer to thereby regulate the oozing thereof to the surface; to use esters having different boiling points or polarities to thereby regulate the oozing thereof to the surface; to control the amounts of surface active agents to thereby improve the coating stability; and to use a lubricant in an increased amount in the nonmagnetic layer to thereby improve the lubricating effect. The additives to be used in the present invention may be entirely or partially added at any steps during the process of producing the coating solutions for the magnetic layer or the nonmagnetic layer. For example, these additives may be with the ferromagnetic powder before kneading. Further, these additives may be added to the system at the step of kneading the ferromagnetic powder with a binder and a solvent. Alternatively, these additives may be added to the system during or after the dispersion step or immediately before the coating step.

[Nonmagnetic Layer]

Next, the nonmagnetic layer will be described in greater detail. The magnetic recording medium according to the invention may have a nonmagnetic layer containing a nonmagnetic powder and a binder on the nonmagnetic support. The nonmagnetic powder to be used in the nonmagnetic layer is either an inorganic material or an organic material. It is also possible to use carbon black, etc. Examples of the inorganic material include a metal, a metal oxide, a metal carbonate, a metal sulfate, a metal nitride, a metal carbide, a metal sulfide and so on.

Specific examples thereof are selected from the following compounds and they can be used either alone or in combination, e.g., titanium oxide such as titanium dioxide, cerium oxide, tin oxide, tungsten oxide, ZnO, ZrO₂, SiO₂, Cr₂O₃, α-alumina having an α-conversion rate of 90% to 100%, β-alumina, γ-alumina, α-iron oxide, goethite, corundum, silicon nitride, titanium carbide, magnesium oxide, boron nitride, molybdenum disulfide, copper oxide, MgCO₃, CaCO₃, SrCO₃, BaSO₄, silicon carbide and titanium carbide. Among all, α-iron oxide and titanium oxide are preferred.

The figure of nonmagnetic powder may be any of acicular, spherical, polyhedral and tabular shapes. The average crystalline size of the nonmagnetic powder is preferably from 4 nm to 500 nm, more preferably from 40 to 100 nm. It is preferable that the crystalline size falls within the range of 4 nm to 500 nm, since an appropriate surface roughness can be achieved without interfering the dispersion. The average particle diameter of these nonmagnetic powder is preferably from 5 nm to 500 nm. A plurality of nonmagnetic powders each having a different particle diameter may be combined, if necessary, or a single nonmagnetic powder having a broad particle diameter distribution may be employed so as to attain the same effect as such a combination. A particularly preferred particle diameter of nonmagnetic powder is from 10 to 200 nm. It is preferable that the average particle diameter of the nonmagnetic powders falls within the range of 5 nm to 500 nm, since dispersion can be favorably conducted and an appropriate surface roughness can be obtained thereby.

The specific surface area of the nonmagnetic powder to be used in the present invention is from 1 to 150 m²/g, preferably from 20 to 120 m²/g, and more preferably from 50 to 100 m²/g. It is preferable that the specific surface area falls within the range of 1 to 150 m²/g, since an appropriate surface roughness can be achieved and dispersion can be made by using the binder in a desired amount in this case. The oil absorption amount using DBP (dibutyl phthalate) thereof is from 5 to 100 ml/100 g, preferably from 10 to 80 ml/100 g, and more preferably from 20 to 60 ml/100 g. The specific gravity there of is from 1 to 12, and preferably from 3 to 6. The tap density of is from 0.05 to 2 g/ml, preferably from 0.2 to 1.5 g/ml. So long as the tap density falls within the scope of 0.05 to 2 g/ml, few particles scatter and thus the nonmagnetic powder can be easily handled. Moreover, it scarcely sticks to a device in this case. The pH value of the nonmagnetic powder is preferably from 2 to 11, more preferably from 6 to 9. So long as the pH value falls within the range of 2 to 11, the coefficient of friction would not be elevated due to high temperature, high humidity or leaving fatty acids. The water content of the nonmagnetic powder is from 0.1 to 5% by mass, preferably from 0.2 to 3% by mass and more preferably from 0.3 to 1.5% by mass. It is preferable that the water content falls within the range of 0.1 to 5% by mass, since favorable dispersion can be achieved and stable coating viscosity can be obtained after the dispersion in this case. The ignition loss thereof is preferably 20% by mass or less and a smaller ignition loss is preferred.

In the case where the nonmagnetic powder is an inorganic powder, the Mohs' hardness thereof is preferably from 4 to 10. So long as the Mohs' hardness falls within the range of 4 to 10, a high durability can be ensured. The stearic acid adsorption amount of the nonmagnetic powder is from 1 to 20 μmol/m², preferably from 2 to 15 μmol/m². The heat of wetting of the nonmagnetic powder in water at 25° C. is preferably from 200 to 600 erg/cm² (200 to 600 mJ/m²). Also, use can be made of a solvent having a heat of wetting within this range. The water molecule amount on the surface at 100 to 400° C. is appropriately from 1 to 10 molecules/100 ang. The isoelectric point thereof in water is preferably from 3 to 9. It is preferable that the nonmagnetic powder is surface-coated so that there is Al₂O₃, SiO₂, TiO₂, ZrO₂, SnO₂, Sb₂O₃ or ZnO. Al₂O₃, SiO₂, TiO₂ and ZrO₂ are particularly preferable and Al₂O₃, SiO₂ and ZrO₂ are more preferable. Either one of these compounds or a combination thereof may be used. Furthermore, use can be made of a surface treated layer formed by coprecipitation, if necessary. Alternatively, surface treatment of particles may be previously performed with alumina in the first place, then the alumina-coated surface may be treated with silica, or vice versa. A surface treated layer may be porous, if necessary, thought a homogeneous and dense surface is generally preferred.

Specific examples of the nonmagnetic powder to be used in the nonmagnetic layer in the invention include Nanotite (manufactured by Showa Denko Co., Ltd.), HIT-100 and ZA-G1 (manufactured by Sumitomo Chemical Co., Ltd.), DPN-250, DPN-250BX, DPN-245, DPN-270BX, DPB-550BX and DPN-550RX (manufactured by Toda Kogyo Co., Ltd.), titanium oxide TTO-51B, TTO-55A, TTO-55B, TTO-55C, TTO-55S, TTO-55D, SN-100, MJ-7, α-iron oxide E270, E271 and E300 (manufactured by Ishihara Sangyo Kaisha K.K.), STT-4D, STT-30D, STT-30 and STT-65C (manufactured by Titan Kogyo Co., Ltd.), MT-100S, MT-100T, MT-150W, MT-500B, MT-600B, T-100F and T-500HD (manufactured by Teika Co., Ltd.), FINEX-25, BF-1, BF-10, BF-20 and ST-M (manufactured by Sakai Chemical Industry Co., Ltd.), DEFIC-Y and DEFIC-R (manufactured by Dowa Mining Co., Ltd.), AS2BM and TiO₂ P25 (manufactured by Nippon Aerosil Co., Ltd.), and 10A, and 500A (manufactured by Ube Industries, Ltd.), Y-LOP (manufactured by Titan Kogyo Co., Ltd.) and calcined products of them. Particularly preferred nonmagnetic powders are titanium dioxide and alpha-iron oxide.

By incorporating carbon blacks into the nonmagnetic layer, a desired micro Vickers' hardness can be obtained in addition to the effects of reducing surface electrical resistance and light transmittance. The micro vickers hardness of the nonmagnetic layer is usually from 25 to 60 kg/mm² (245 to 588 MPa), preferably from 30 to 50 kg/mm² (294 to 490 MPa) for improving the smoothness in the contact with the head. The micro vickers hardness can be measured by using a thin film hardness tester (Model HMA-400 manufactured by NEC Corp.). The tip of the penetrator used is a triangular pyramid made of diamond with a tip sharpness of 80° and a tip radius of 0.1 μm. The measurement procedure is described in detail in Hakumaku no Rikigakuteki Tokusei Hyouka Gijutu, Realize Corp. Concerning light transmittance, it is generally specified that the absorption of infrared rays of about 900 nm in wavelength is 3% or less. In the case of a VHS magnetic tape, for example, the absorption thereof is standardized as 0.8% or less. To satisfy this requirement, use can be made of furnace black for rubber, thermal black for rubber, acetylene black, and so on.

The carbon black to be used in the nonmagnetic layer of the invention preferably has a specific surface area of 100 to 500 m²/g, more preferably 150 to 400 m²/g, and an oil absorption of 20 to 400 ml/100 g, more preferably 30 to 200 ml/100 g as determined with DBP. The carbon black has an average particle diameter of 5 to 80 nm, more preferably 10 to 50 nm, particularly preferably 10 to 40 nm. The carbon black preferably has a pH value of 2 to 10, a water content of 0.1 to 10% and a tap density of 0.1 to 1 g/ml.

Specific examples of the carbon black that is usable in the nonmagnetic layer of the invention include BLACKPEARLS 2000, 1300, 1000, 900, 800, 880 and 700, VULCAN XC-72 (manufactured by Cabot Corp.), #3050B, #3150B, #3250B, #3750B, #3950B, #950, #650B, #970B, #850B and MA-600 (manufactured by Mitsubishi Kasei Corp.), CONDUCTEX SC, RAVEN 8800, 8000, 7000, 5750, 5250, 3500, 2100, 2000, 1800, 1500, 1255 and 1250 (manufactured by Columbia Carbon Corp.), and Ketchen Black EC (manufactured by Aczo Corp.).

These carbon blacks may be surface-treated with a dispersant, grafted with a resin or partially graphtized before using. These carbon blacks may be dispersed by using a binder before adding to the coating. These carbon blacks may be used in an amount not exceeding 50% by mass based on the mass of the foregoing inorganic powder or not exceeding 40% by mass based on the total mass of the nonmagnetic layer. These carbon blacks may be used singly or in combination. For the details of the carbon black usable in the nonmagnetic layer of the present invention, reference can be made to Kabon Burakku Binran, edited by Kabon Burakku Kyokai.

Further, an organic powder may be added to the nonmagnetic layer depending on the purpose. Examples of the organic powder include an acryl styrene-based resin powder, a benzoguanamine resin powder, a melamine-based resin powder and a phthalocyanine-based pigment. Use can be also made of a polyolefin-based resin powder, a polyester-based resin powder, a polyamide-based resin powder, a polyimide-based resin powder, and a polyfluoroethylene resin. To prepare these organic powders, use can be made of a methods described in JP-A-62-18564 and JP-A-60-255827.

For the binder, lubricant, dispersant, and additives to be incorporated in the nonmagnetic layer and the method for dispersing these components and solvents used therefor, those used for the magnetic layer can be employed. In particular, for the amount and kind of the binder, additives and dispersant, the publicly known technique for the magnetic layer can be employed.

The magnetic recording medium according to the invention may be further provided with an undercoating layer. By forming the undercoating layer, the adhesive force between the support and the magnetic layer or the nonmagnetic layer can be improved. As the undercoating layer, a polyester resin soluble in solvents may be employed.

[Layer Constitution]

Concerning the thickness constitution of the magnetic recording medium of the present invention, the thickness of the nonmagnetic layer is from 3 to 80 μm, preferably from 3 to 50 μm and particularly preferably from 3 to 10 μm as discussed above. In the case where an undercoating layer is provided between the nonmagnetic support and the nonmagnetic layer, the thickness of the undercoating layer is from 0.01 to 0.8 μm, preferably from 0.02 to 0.6 μm.

The thickness of the magnetic layer can be optimally selected according to the saturation magnetization amount of the magnetic head used, the head gap length, and the recording signal zone, and is preferably from 10 to 150 nm, more preferably from 20 to 120 nm and more preferably from 30 to 100 nm. The variation in the thickness of the magnetic layer is preferably within ±50%, more preferably within ±30%. The magnetic layer may comprise at least one layer. It may comprise two or more layers having different magnetic characteristics and well-known multilayer magnetic layer structures can be applied to the present invention.

The thickness of the nonmagnetic layer according to the present invention is generally from 0.1 to 3.0 μm, preferably from 0.3 to 2.0 μm, and more preferably from 0.5 to 1.5 μm. The nonmagnetic layer in the present invention exhibits the effect of the present invention so long as it is substantially nonmagnetic even if, or intentionally, it contains a small amount of a magnetic powder as an impurity, which is as a matter of course regarded as essentially the same construction as in the present invention. The term “essentially the same” means that the residual magnetic flux density of the nonmagnetic layer is 10 mT or less or the antimagnetic force of the nonmagnetic layer is 7.96 kA/m (100 Oe), preferably the residual magnetic flux density and the antimagnetic force are zero.

[Back Layer]

The magnetic recording medium according to the invention has a backcoat layer formed on the other face of the nonmagnetic support. It is required that the glass transition temperature of the backcoat layer is from 65 to 95° C. and the binder constituting the backcoat layer satisfies all of the following requirements (1) to (5):

(1) comprising a vinyl chloride-based resin and a polyurethane resin as the main components;

(2) the solubility parameter of the vinyl chloride-based resin being from 9 to 11 (cal·cm⁻³)^{1/2}, the glass transition temperature thereof being from 65 to 95° C. and the weight-average molecular weight thereof being from 5000 to 25000;

(3) the ratio of the vinyl chloride-based resin to the total mass of the vinyl chloride-based resin and the polyurethane resin being from 10 to 60% by mass;

(4) the solubility parameter of the polyurethane resin being from 9.5 to 11.5 (cal·cm⁻³)^{1/2}, the glass transition temperature thereof being from 80 to 110° C. and the weight-average molecular weight thereof being from 20000 to 60000; and

(5) the ratio of the polyurethane resin to the total mass of the vinyl chloride-based resin and the polyurethane resin being from 90 to 30% by mass.

In addition to the binder as will be described hereinafter, the backcoat layer in the invention preferably contains carbon black or an inorganic powder. As various additives to be added besides them, the formulations for the magnetic layer and the nonmagnetic layer are applicable. The thickness of the backcoat layer is preferably from 0.1 to 1.0 μm, more preferably from 0.2 to 0.8 μm.

The backcoat layer in the invention has a glass transition temperature of from 65 to 95° C., more preferably from 70 to 90° C. and more preferably from 75 to 85° C. The “glass transition temperature Tg)” as used herein is defined as the peak temperature in a E″ temperature-dependency curve that is obtained by measuring the temperature-dependency of dynamic viscoelasticity measurement at 110 Hz while elevating temperature at a speed of 3° C./min.

When the glass transition temperature of the backcoat layer is lower than 65° C., stickiness frequently arises between the magnetic layer and the backcoat layer in the course of a heat treatment that is conducted in order to promote crosslinkage of a binder resin or relieve the enthalpy of the nonmagnetic support. When the glass transition temperature exceeds 95° C., on the other hand, crosslinkage scarcely arises and the coating film becomes fragile. As a result, there arise some troubles such that the cut edge cracks in cutting the tape and a coating film peels off from the tape during running and transfers to the magnetic layer to thereby cause drop out.

<Binder>

The term “SP value” as used herein is an abbreviation for “solubility parameter” that numerically represents the polarity of a compound. That is, it can be understood whether a binder is a hydrophilic or hydrophobic nature based on its SP value. A binder having a higher SP value is the more hydrophilic, while a binder having a lower SP value is the more hydrophobic.

In the invention, a combination of binders having appropriate hydrophilicity for using in the backcoat layer of the magnetic recording medium is selected on the basis of SP values. As methods for determining the SP value of a binder, Kagaku Binran, 2^{nd} revised ed., p. 831 (ed. by The Chemical Society of Japan) discloses the method of determining SP value of a binder based on the solubility thereof in a solvent having a known SP value, swelling properties and limiting viscosity, and the method of calculating the SP value in accordance with Small's equation and Florry-Huggins' parameter. In the invention, an appropriate combination of binders is selected by using these methods too.

The binder to be used in the backcoat layer of the invention comprises a vinyl chloride-based resin and a polyurethane resin as the main components. The term “main components” as used herein means these components amount to 60% by mass or more based on the whole binder used in the backcoat layer.

The ratio of the vinyl chloride-based resin to the total mass of the vinyl chloride-based resin and the polyurethane resin being from 10 to 60% by mass. When the amount of the vinyl chloride-based resin is less than 10% by mass, the dispersibility of a nonmagnetic powder such as carbon black is worsened. When it exceeds 60% by mass, the coating film becomes less flexible and there arise some problems such that the cut edge cracks in cutting the tape and a coating film peels off from the tape during running and transfers to the magnetic layer to thereby cause drop out.

It is preferable to adjust the SP value of the vinyl chloride-based resin to 9 to 11 (cal·cm⁻³)^{1/2}, more preferably 9.5 to 10.5 (cal·cm⁻³)^{1/2}. When the SP value is lower than 9 (cal·cm⁻³)^{1/2}, the dispersibility of a magnetic material/nonmagnetic powder is lowered and the adhesiveness to the nonmagnetic support is worsened. When it exceeds 11 (cal·cm⁻³)^{1/2}, the hydrophilicity is elevated and the solubility in a solvent is lowered. In this case, furthermore, the hygroscopicity of the magnetic tape is elevated and thus the dimensional stability of the tape is worsened at a high humidity.

The glass transition temperature of the vinyl chloride-based resin to be used in the invention is preferably from 65 to 95° C., more preferably from 70 to 90° C. When the glass transition temperature is lower than 65° C., stickiness frequently arises between the magnetic layer and the backcoat layer in the course of a heat treatment that is conducted in order to promote crosslinkage of a binder resin or relieve the enthalpy of the nonmagnetic support. When the glass transition temperature exceeds 95° C., on the other hand, crosslinkage scarcely arises and the coating film becomes fragile. As a result, there arise some troubles such that the cut edge cracks in cutting the tape and a coating film peels off from the tape during running and transfers to the magnetic layer to thereby cause drop out.

The weight-average molecular weight of the vinyl chloride-based resin to be used in the invention is preferably from 5000 to 25000, more preferably from 10000 to 20000. When the weight-average molecular weight is lower than 5000, stickiness frequently arises between the magnetic layer and the backcoat layer in the course of a heat treatment that is conducted in order to promote crosslinkage of a binder resin or relieve the enthalpy of the nonmagnetic support. When the weight-average molecular weight exceeds 25000, on the other hand, crosslinkage scarcely arises and the coating film becomes fragile. As a result, there arise some troubles such that the cut edge cracks in cutting the tape and a coating film peels off from the tape during running and transfers to the magnetic layer to thereby cause signal loss.

The ratio of the polyurethane resin to the total mass of the vinyl chloride-based resin and the polyurethane resin being from 90 to 30% by mass. When the amount of the polyurethane resin is more than 90% by mass, the dispersibility of a nonmagnetic powder such as carbon black is worsened. When it is less than 30% by mass, the coating film becomes less flexible and there arise some problems such that the cut edge cracks in cutting the tape and a coating film peels off from the tape during running and transfers to the magnetic layer to thereby cause drop out.

It is preferable to adjust the SP value of the polyurethane resin to 9.5 to 11.5 (cal·cm⁻³)^{1/2}, more preferably 10.0 to 11.0 (cal·cm⁻³)^{1/2}. When the SP value is lower than 9.5 (cal·cm⁻³)^{1/2}, the dispersibility of a nonmagnetic powder is lowered and the adhesiveness to the nonmagnetic support is worsened. When it exceeds 11.5 (cal-cm³)^{1/2}, the hydrophilicity is elevated and the solubility in a solvent is lowered. In this case, furthermore, the hygroscopicity of the magnetic tape is elevated and thus the dimensional stability of the tape is worsened at a high humidity.

The glass transition temperature of the polyurethane resin to be used in the invention is preferably from 80 to 110° C., more preferably from 80 to 95° C.

When the glass transition temperature is lower than 80° C., stickiness frequently arises between the magnetic layer and the backcoat layer in the course of a heat treatment that is conducted in order to promote crosslinkage of a binder resin or relieve the enthalpy of the nonmagnetic support. When the glass transition temperature exceeds 110° C., on the other hand, crosslinkage scarcely arises and the coating film becomes fragile. As a result, there arise some troubles such that the cut edge cracks in cutting the tape and a coating film peels off from the tape during running and transfers to the magnetic layer to thereby cause signal loss.

The binder to be used in the backcoat layer of the invention can contain from 2 to 7 eq/ton of at least one polar group selected from —SO₃M, —OSO₃M, —PO(OM)₂, —OPO(OM)₂ and —COOM (in which M represents a hydrogen atom, an alkaline metal or an ammonium salt), and from 5 to 50 eq/ton of at least one polar group selected from —CONR₁R₂, —NR₁R₂ and —NR₁R₂R₃+(wherein R₁, R₂ and R₃ independently represent each a hydrogen atom or an alkyl group). The term “alkyl group” as used herein means a saturated hydrocarbon group having from 1 to 18 carbon atoms which may have either a linear structure or a branched structure. The content of at least one polar group selected from —SO₃M, —OSO₃M, —PO(OM)₂, —OPO(OM)₂ and —COOM (in which M represents a hydrogen atom, an alkaline metal or an ammonium salt) is from 2 to 7 eq/ton, preferably from 2.5 to 6 eq/ton and more preferably from 3 to 5 eq/ton. The content of at least one polar group selected from —CONR₁R₂, —NR₁R₂ and —NR₁R₂R₃⁺ (wherein R₁, R₂ and R₃ independently represent each a hydrogen atom or an alkyl group) is from 5 to 50 eq/ton, preferably from 10 to 40 eq/ton and more preferably from 15 to 35 eq/ton. Thus, a magnetic material or a nonmagnetic powder can be favorably dispersed therein.

As discussed above, the backcoat layer in the invention comprises a vinyl chloride-based resin and a polyurethane resin as the main components. Moreover, it may contain other resin(s) together. These resins usable together are not particularly restricted. Thus, use can be made of the above-described thermoplastic resins, thermosetting resins, reactive resins and mixture thereof.

[Polyurethane Resin]

Preferable examples of the polyurethane resin to be used as a binder in the backcoat layer of the invention include:

(1) a polyurethane resin obtained by causing a reaction between a polyol of molecular weight 500 to 5000 having a ring structure and an alkylene oxide chain, another polyol of molecular weight 200 to 500 having a ring structure and serving as a chain extender, and organic diisocyanate.

As the polyol with a ring structure and an alkylene oxide chain as described above, use can be made of an alkylene oxide, such as an ethylene oxide, a propylene oxide, etc., added to diol having a ring structure. Examples of diol are bisphenol A, bisphenol hydride A, bisphenol S, bisphenol hydride S, bisphenol P, bisphenol hydride P, tricyclodecanedimethanol, cyclohexanedimethanol, cyclohexanediol, 5,5′-(1-methyleethylidene)bis-(1,1′-bicyclohexyl)-2-ol, 4,4′-(1-methyleethylidene)bis-2-methylcyclohexanol, 5,5′-(1,1′-cyclohexylidene)bis-(1,1′-bicyclohexyl)-2-ol, 5,5′-(1,1′-cyclohexylmethylene)bis-(1,1′-bicyclohexyl)-2-ol, hydroterpenediphenol, diphenolbisphenol A, diphenolbisphenol S, diphenolbisphenol P, 9,9′-bis-(4-hydroxyphenyl)fluorene, 4,4′-(3-methylethylidene)bis(2-cyclohexyl-5-methylphenol), 4,4′-(3-methylethylidene)bis(2-phenyl-5-methylcyclohexanol), 4,4′-(1-phenylethylidene)bis(2-phenol), 4,4′-(cyclohexyliden)bis(2-methylphenol), terpenediphenol, and so on. Among them, bisphenol hydride A, and a polypropylene oxide added to bisphenol hydride A are preferred. It is preferable that the molecular weight of the above-described polyol is from 500 to 5000. When the molecular weight is 500 or more, then the concentration of the urethane group is low and therefore solvent solubility is high. When it is 5000 or less, then coating strength is good and therefore a high durability can be achieved.

As the polyol with a ring structure which is employed as a chain extender, use can be made of an alkylene oxide, such as an ethylene oxide, a propylene oxide, etc., added in a range of molecular weight 200 to 500 to the above-described diol having a ring structure. Bisphenol hydride A, and a polypropylene oxide added to bisphenol hydride A, are preferable.

(2) A polyurethane resin obtained by causing a reaction between a polyesterpolyol consisting of an aliphatic diol having no ring structure which has an aliphatic dibasic acid and an alkyl branch side chain, an aliphatic diol having a branch alkyl side chain whose carbon number is 3 or more and serving as a chain extender, and an organic diisocyanate compound.

The above-described polyesterpolyol consists of an aliphatic diol having no ring structure which has an aliphatic dibasic acid and an alkyl branch side chain. As the aliphatic dibasic acid, use can be made of aliphatic dibasic acids such as succinic acid, adipic acid, azelaic acid, sebasic acid, malonic acid, glutaric acid, pimelic acid, suberic acid, and so on. Among them, succinic acid, adipic acid, and sebasic acid are preferable. In all dibasic acid components in the polyesterpolyol, the aliphatic dibasic acid content is preferably 70 mol % or more. When the content thereof is 70 mol % or more, the concentration of dibasic acid having a ring structure is practically low and therefore solvent solubility is high. Thus, favorable dispersibility can be established.

As the aliphatic polyol, which can be employed in polyesterpolyol, having no ring structure that has an alkyl branch side chain, use can be made of aliphatic diols such as 2,2-dimethyl-1,3-propanediol, 3,3-dimethyl-1,5-pentanediol, 2-methyl-2-ethyl-1,3-propanediol, 3-methyl-3-ethyl-1,5-pentanediol, 2-methyl-2-propyl-1,3-propanediol, 3-methyl-3-propyl-1,5-pentanediol, 2-methyl-2-butyl-1,3-propanediol, 3-methyl-3-butyl-1,5-pentanediol, 2,2-diethyl-1,3-propanediol, 3,3-diethyl-1,5-pentanediol, 2-ethyl-2-butyl-1,3-propanediol, 3-ethyl-3-butyl-1,5-pentanediol, 2-ethyl-2-propyl-1,3-propanediol, 3-ethyl-3-propyl-1,5-pentanediol, 2,2-dibutyl-1,3-propanediol, 3,3-dibutyl-1,5-pentanediol, 2,2-dipropyl-1,3-propanediol, 3,3-dipropyl-1,5-pentanediol, 2-butyl-2-propyl-1,3-propanediol, 3-butyl-3-propyl-1,5-pentanediol, 2-ethyl-1,3-propanediol, 2-propyl-1,3-propanediol, 2-butyl-1,3-propanediol, 3-ethyl-1,5-pentanediol, 3-propyl-1,5-pentanediol, 3-butyl-1,5-pentanediol, 3-octyl-1,5-pentanediol, 3-myristil-1,5-pentanediol, 3-stearyl-1,5-pentanediol, 2-ethyl-1,6-hexanediol, 2-propyl-1,6-hexanediol, 2-butyl-1,6-hexanediol, 5-ethyl-1,9-nonanediol, 5-propyl-1,9-nonanediol, 5-butyl-1,9-nonanediol, and so on. Among them, 2,2-dimethyl-1,3-propanediol, 2-ethyl-2-butyl-1,3-propanediol, and 2,2-diethyl-1,3-propanediol are preferable. The polyol content having a branch side chain, which is employed in polyesterpolyol, is preferably in a range of 50 to 100 mol % and further preferably in a range of 70 to 100 mol %. So long as the content falls within this range, solvent solubility is high and therefore good dispersibility can be obtained.

As a chain extender, use can be made of an aliphatic diol having a branch alkyl side chain whose carbon number is 3 or more. Since the aliphatic diol has a branch alkyl side chain whose carbon number is 3 or more, solvent solubility is enhanced and therefore good dispersibility can be obtained. As the aliphatic diol having a branch alkyl side chain whose carbon number is 3 or more, use can be made of 2-methyl-2-ethyl-1,3-propaneiol, 3-methyl-3-ethyl-1,5-pentanediol, 2-methyl-2-propyl-1,3-propanediol, 3-methyl-3-propyl-1,5-pentanediol, 2-methyl-2-butyl-1,3-propanediol, 3-methyl-3-butyl-1,5-pentanediol, 2,2-diethyl-1,3-propanediol, 3,3-diethyl-1,5-pentanediol, 2-ethyl-2-butyl-1,3-propanediol, 3-ethyl-3-butyl-1,5-pentanediol, 2-ethyl-2-propyl-1,3-propanediol, 3-ethyl-3-propyl-1,5-pentanediol, 2,2-dibutyl-1,3-propanediol, 3,3-dibutyl-1,5-pentanediol, 2,2-dipropyl-1,3-propanediol, 3,3-dipropyl-1,3-pentanediol, 2-butyl-2-propyl-1,3-propanediol, 3-butyl-3-propyl-1,5-pentanediol, 2-ethyl-1,3-propanediol, 2-propyl-1,3-propanediol, 2-butyl-1,3-propanediol, 3-ethyl-1,5-pentanediol, 3-propyl-1,5-pentanediol, 3-butyl-1,5-pentanediol, 3-octyl-1,5-pentanediol, 3-myristil-1,5-pentanediol, 3-stearyl-1,5-pentanediol, 2-ethyl-1,6-hexanediol, 2-propyl-1,6-hexanediol, 2-butyl-1,6-hexanediol, 5-ethyl-1,9-nonanediol, 5-propyl-1,9-nonanediol, 5-butyl-1,9-nonanediol, and so on. Among them, 2-ethyl-2-butyl-1,3-propanediol and 2,2-diethyl-1,3-propanediol are preferable. The aliphatic diol content of the polyurethane resin is preferably from 5 to 30% by mass and more preferably from 10 to 20% by mass. In this range, solvent solubility is high and therefore good dispersibility can be obtained.

(3) A polyurethane resin obtained by causing a reaction between a polyol compound having a ring structure and an alkyl chain whose carbon number is 2 or more, and an organic diisocyanate.

As the polyol compound having a ring structure and an alkyl chain whose carbon number is 2 or more, a diol having a molecular weight of 500 to 1000 is preferred. In the case where the polyol compound is a diol, gelation due to crosslinkage would not arise in the course of the polyurethane polymerization. In the case where the carbon number of the alkyl chain of the above-described diol is 2 or more, further, solvent solubility is high and therefore dispersibility is good. When the molecular weight is 500 or more, the concentration of the urethane group is low and therefore solubility is high. When it is 1000 or less, a favorable coating film strength is established. As the polyol which has a ring structure and an alkyl chain whose carbon number 2 or more, a dimer diol obtained by hydrogenating and deoxidizing dimeric acid is preferred.

It is preferable that the diol, which has a ring structure and an alkyl chain whose carbon number is 2 or more, is contained in an amount of from 5 to 60% by mass, more preferably from 10 to 40% by mass, in the polyurethane resin. When the content of the diol having a ring structure and an alkyl chain whose carbon number is 2 or more is within the above-described range, solvent solubility is high and therefore dispersibility is good. Furthermore, durability can be enhanced in this case.

In the present invention, the organic diisocyanate to be reacted with the above-described polyol to produce the polyurethane resin is not particularly limited. Namely, use can be made of organic diisocyanates commonly employed. Examples thereof include hexamethylenediisocyanate, tridinediisocyanate, isophoronediisocyanate, 1,3-xylilenediisocyanate, 1,4-xylilenediisocyanate; cyclohexanediisocyanate, toluidinediisocyanate, 2,4-tolylenediisocyanate, 2,6-tolylenediisocyanate, 4,4′-diphenylmethanediisocyanate, p-phenylenediisocyanate, m-phenylenediisocyanate, 1,5-naphthalenediisocyanate, 3,3-dimethylphenylenediisocyanate, and so on.

In the case of producing the polyurethane resin having a polar group as described above, the polyurethane resin can be obtained from a starting monomer containing at least one polar group selected from —SO₃M, —OSO₃M, —PO(OM)₂, —OPO(OM)₂ and —COOM (in which M represents a hydrogen atom, an alkaline metal or an ammonium salt), and/or at least one polar group selected from —CONR₁R₂, —NR₁R₂ and —NR₁R₂R₃+(wherein R₁, R₂ and R₃ independently represent each a hydrogen atom or an alkyl group) having been introduced thereinto. For example, use can be made of: (1) a method of producing from a polyol having a polar group such as a polyester polyol or a polyether polyol having a polar group, a polyol having no polar group such as a polyester polyol or a polyether polyol and a diisocyanate; and (2) a method of producing by substituting a portion of a dihydric alcohol or a dibasic acid by a diol having a polar group or a dibasic acid having a polar group.

The polar-group contained polyurethane resin to be employed in the present invention preferably has OH— groups from the viewpoints of curing properties and durability. The number of OH— groups is preferably from 2 to 40 per molecule and more preferably from 3 to 20 per molecule.

In the present invention, a polyurethane resin other than the above-described polyurethane resin can also be used together. It is preferable that the polyurethane resin to be used together has a similar polar group as in the polyurethane resin as described above.

[Vinyl Chloride-Based Resin]

As a vinyl chloride-based resin which is particularly preferable as a binder to be used in the backcoat layer in the invention, use can be made of copolymers of vinyl chloride monomer with various monomers. Examples of these copolymerizable monomers include fatty acid vinyl esters such as vinyl acetate and vinyl propionate; acrylates and methacrylates such as methyl(meth)acrylate, ethyl(meth)acrylate, isopropyl(meth)acrylate, butyl(meth)acrylate and benzyl(meth)acrylate; alkyl allyl ethers such as allyl methyl ether, allyl ethyl ether, allyl propyl ether and allyl butyl ether, styrene, α-methylstyrene, vinylidene chloride, acrylonitrile, ethylene, butadiene, acrylamide and so on. As copolymerizable monomers having a functional group, use can be also made of vinyl alcohol, 2-hydroxyethyl(meth)acrylate, polyethylene glycol (meth)acrylate, 2-hydroxypropyl(meth)acrylate, 3-hydroxypropyl(meth)acrylate, polypropylene glycol (meth)acrylate, 2-hydroxyethyl allyl ether, 2-hydroxypropyl allyl ether, 3-hydroxypropyl allyl ether, p-vinylphenol, maleic acid, maleic anhydride, acrylic acid, methacrylic acid, glycidyl(meth)acrylate, allyl glycidyl ether, phosphoethyl(meth)acrylate, sulfoethyl(meth)acrylate, p-methylenesulfonic acid and Na salts and K salts thereof.

It is preferable that the content of the vinyl chloride monomer in the vinyl chloride-based resin amounts to 75 to 95% by weight, since a high mechanical strength, a favorable solubility and a favorable dispersibility of the inorganic powder can be established in this case.

The vinyl chloride-based resin having a polar group as described above can be obtained by copolymerizing a copolymerizable polar group-containing compound, which contains at least one polar group selected from —SO₃M, —OSO₃M, —PO(OM)₂, —OPO(OM)₂ and —COOM (in which M represents a hydrogen atom, an alkaline metal or an ammonium salt) and/or at least one polar group selected from —CONR₁R₂, —NR₁R₂ and —NR₁R₂R₃⁺ (wherein R₁, R₂ and R₃ independently represent each a hydrogen atom or an alkyl group), with a vinyl chloride monomer and other copolymerizable compound(s).

Examples of a copolymerizable group for introducing —SO₃M include unsaturated hydrocarbon sulfonic acids such as 2-acrylamide-2-methylpropanesulfonic acid, vinylsulfonic acid, (meth)acrylsulfonic acid and p-styrenesulfonic acid and salts thereof, and sulfoalkyl esters such as sulfoethyl(meth)acrylate and sulfopropyl (meth)acrylate and salts thereof. The hydrophilic polar groups as described above may be used either singly or as a combination of two or more thereof. In the case where —NR₂ should be introduced in addition to —SO₃M, use can be made of a copolymerizable compound containing —NR₂ such as N,N-dimethylaminopropylacrylamide or N-isopropylacrylamide.

For introducing a polar group, use may be made of a method of copolymerizing a monomer mixture using a polar group-containing radical polymerization initiator at the production of a copolymer, and a method of copolymerizing a monomer mixture in the presence of a chain transfer agent having a polar group at one terminal at the production of a copolymer. Examples of the polar group-containing radical polymerization initiator include ammonium persulfate, potassium persulfate and sodium persulfate. The amount of this radical polymerization initiator used is suitably from 1 to 10% by mass, preferably from 1 to 5% by mass, based on the total amount of the monomers. The chain transfer agent having a polar group at one terminal is not particularly limited so far as it can undertake the chain transfer in the polymerization reaction and at the same time, contains a polar group at one terminal, and examples thereof include halogenated compounds and mercapto compounds having a polar group at one terminal, and diphenyl picryl hydrazine. Specific examples of the halogenated compound include 2-chloroethanesulfonic acid, sodium 2-chloroethanesulfonate, 4-chlorophenylsulfoxide, 4-chlorobenzenesulfonamide, p-chlorobenzenesulfonic acid, sodium p-chlorobenzenesulfonate, sodium 2-bromoethanesulfonate and sodium 4-(bromomethyl)-benzenesulfonate. Among them, sodium 2-chloroethanesulfonate and sodium p-chlorobenzenesulfonate are preferred. Examples of the mercapto compound which is preferably used include 2-mercaptoethanesulfonic acid (or a salt thereof), 3-mercapto-1,2-propanediol, mercaptoacetic acid (or a salt thereof), 2-mercapto-5-benzimidazolesulfonic acid (or a salt thereof), 3-mercapto-2-butanol, 2-mercaptobutanol, 3-mercapto-2-propanol, N-(2-mercaptopropyl)glycine, ammonium thioglycolate and β-mercaptoethylamine hydrochloride. These chain transfer agents having a polar group at one terminal can be used singly or in combination of two or more thereof. The chain transfer agent having a polar group at one terminal, which is particularly preferred, is 2-mercaptoethanesulfonic acid (or a salt thereof) having strong polarity. The amount of the chain transfer agent used is preferably from 0.1 to 10% by mass, more preferably from 0.2 to 5% by mass, based on the total amount of the monomers.

It is also preferred to introduce a hydroxyl group into the vinyl chloride-based resin in the present invention. It can be achieved by copolymerizing a copolymerizable compound having a hydroxyl group with a vinyl chloride monomer and other copolymerizable compound(s). Examples of the copolymerizable hydroxyl group-containing unit include hydroxyalkyl(meth)acrylates such as hydroxyethyl (meth)acrylate, hydroxypropyl(meth)acrylate, polyethylene glycol mono(meth)acrylate, polypropylene glycol mono(meth)acrylate, polyethylene glycol polypropylene glycol mono(meth)acrylate, glycerol mono(meth)acrylate and 3-chloro-2-hydroxypropyl(meth)acrylate; vinyl ethers such as hydroxyethyl vinyl ether, hydroxypropyl vinyl ether and hydroxybutyl vinyl ether; (meth)allyl ethers such as hydroxyethyl mono(meth)allyl ether, hydroxypropyl mono(meth)allyl ether, hydroxybutyl mono(meth)allyl ether, diethylene glycol mono(meth)allyl ether, dipropylene glycol mono(meth)allyl ether, glycerol mono(meth)allyl ether and 3-chloro-2-hydroxypropyl mono(meth)allyl ether; and (meth)allyl alcohol. A vinyl alcohol unit may be introduced by copolymerizing vinyl acetate and saponifying the copolymer with a caustic alkali in a solvent. The amount of the monomer having a hydroxyl group is preferably adjusted to from 5 to 30% by mass based on the total monomers.

For polymerizing a polymerization reaction system containing the above-described polymerizable compounds and chain transfer agent, a known polymerization method such as suspension polymerization, emulsion polymerization and solution polymerization can be used. Among these polymerization methods, preferred are suspension polymerization and emulsion polymerization having good dry workability, more preferred is emulsion polymerization, because the obtained acrylic copolymer can be easily stored in the solid state at a high storage stability. The polymerization conditions vary depending on the kind of the polymerizable compounds, polymerization initiator and chain transfer agent used. In general, the preferred conditions for the polymerization in an autoclave are such that the temperature is approximately from 50 to 80° C., the gauge pressure is approximately from 4.0 to 1.0 MPa, and the time period is approximately from 5 to 30 hours. The polymerization is preferably performed in an atmosphere of a gas inert to the reaction because the reaction can be easily controlled in this case. Examples of such a gas include nitrogen and argon, with nitrogen being preferred from an economical viewpoint. At the polymerization, components other than the above-described components may also be added to the polymerization reaction system. Examples of such components include an emulsifier, an electrolyte and a polymer protective colloid.

In the present invention, it is also possible to introduce a crosslinked structure into the backcoat layer by using a known polyisocyanate compound together to thereby improve durability. Examples of the polyisocyanate usable together include isocyanates such as tolylene diisocyanate, 4,4′-diphenylmethane diisocyanate, hexamethylene diisocyanate, xylylene diisocyanate, naphthylene-1,5-diisocyanate, o-toluidine diisocyanate, isophorone diisocyanate and triphenylmethane triisocyanate; reaction products of these isocyanates with polyalcohols; and polyisocyanates formed by condensation reaction of isocyanates. These polyisocyanates are commercially available under the trade names of Coronate L, Coronate HL, Coronate 2030, Coronate 2031, Millionate MR and Millionate MTL (manufactured by Nippon Polyurethane Co., Ltd.), Takenate D-102, Takenate D-110N, Takenate D-200 and Takenate D-202 (manufactured by Takeda Chemical Industries, Ltd.), and Desmodur L, Desmodur IL, Desmodur N and Desmodur HL (manufactured by Sumitomo Bayer Co., Ltd.). These polyisocyanates may be used either singly or in combinations of two or more taking the advantage of a difference in curing reactivity.

The above-described binder can be used in an amount of from 5 to 50 parts by mass per 100 parts by mass of the inorganic powder. By controlling the content thereof to 7 to 45 parts by mass, in particular, favorable dispersion state of the inorganic powder can be achieved. When the content thereof is less than 5 parts by mass, the inorganic powder cannot be bound and there arises, for example, dusting. In the case where the binder is added in an amount more than 50 parts by mass, the dispersion state of the inorganic powder cannot be improved any longer.

[Production Method]

The process for producing a coating composition for the magnetic layer, a coating composition for the nonmagnetic layer or a coating composition for the backcoat layer to be used in the present invention comprises at least a kneading step, a dispersion step, and a mixing step which is optionally provided before or after these steps. These steps each may consist of two or more stages. The raw materials to be used in the present invention, e.g., a ferromagnetic powder, a nonmagnetic powder, a binder, carbon black, an abrasive, an antistatic agent, a lubricant and a solvent may be added to the system at the beginning or during any step. It is also possible to add each of these raw materials in portions to the system at two or more steps. For example, polyurethane may be supplied in portions into the system at the kneading step, the dispersion step or the mixing step for the viscosity adjustment following dispersion. In order to accomplish the objects of the present invention, use can be made of a publicly known production technique one of the steps. In the kneading step, it is preferable to use an apparatus having a strong kneading power such as an open kneader, a continuous kneader, a pressure kneader or an extruder. These kneading techniques are described in detail in JP-A-1-106388 and JP-A-64-79274. To disperse a coating composition for the magnetic layer, a coating composition for the nonmagnetic layer or a coating composition for the backcoat layer, use can be made of glass beads. As these glass beads, zirconia beads and steel beads which are dispersion media having a high specific gravity are preferably used. The particle diameter and packing ratio of these dispersion media may be optimized before using. As a dispersion machine, a publicly known one may be used.

In the method of producing the magnetic recording medium according to the invention, a coating composition for the magnetic layer is applied on the surface of the nonmagnetic support, which is kept running, in such an amount as to give a desired film thickness to thereby form the magnetic layer. In this step, multiple coating compositions for magnetic layer may be simultaneously or successively applied. Also, a coating composition for nonmagnetic layer and a coating solution for magnetic layer may be simultaneously or successively applied. Coating apparatuses usable for applying the coating composition for magnetic layer or the coating composition for nonmagnetic layer as described above include an air doctor coater, a blade coater, a rod coater, an extrusion coater, an air knife coater, a squeeze coater, an impregnation coater, a reverse-roll coater, a transfer roll coater, a gravure coater, a kiss coater, a cast coater, a spray coater, and spin coater. With respect to these coating apparatuses, reference may be made, for example, to Saishin Kotingu Gijutsu, published by Sogo Gijutsu Center K.K. (May 31, 1983).

In the case of a magnetic tape, the coating layer of the magnetic layer coating composition may be subjected to a magnetic orientation treatment to the ferromagnetic powder contained in the coating layer of the magnetic layer coating composition with the use of a cobalt magnet or a solenoid. In the case of a disk, a sufficiently isotropic orienting property may be obtained without performing orientation using an orientation apparatus. However, it is preferable to employ a publicly known random orientation apparatus, where cobalt magnets are diagonally and alternately located or an AC magnetic field is applied by a solenoid. As for the isotropic orientation, in the case of a ferromagnetic metal fine powder, in-plane two dimensional random orientation is generally preferred but three dimensional random orientation may also be provided by incorporating a vertical component. In the case of hexagonal ferrite, three dimensional random orientation of in-plane and in the vertical direction is readily provided in general, however, in-plane two dimensional random orientation can also be provided. Furthermore, vertical orientation may be provided using a well-known method such as different pole and counter position magnet to have isotropic magnetic characteristics in the circumferential direction. In particular, when high-density recording is performed, vertical orientation is preferred. Also, circumferential orientation may be provided using spin coating.

The drying position of the coating is preferably controlled by controlling the temperature and amount of drying air and the coating speed. The coating speed is preferably from 20 m/min to 1000 m/min and the temperature of drying air is preferably 60° C. or higher. Furthermore, preliminary drying may also be appropriately performed before entering the magnet zone.

The coated master roll thus obtained is once wound using a winding roll and then unwound from the winding roll followed by a calendaring treatment.

In the calendaring treatment, for example, a supercalender roll can be used. By performing the calendaring treatment, the surface smoothness is improved, holes formed due to the removal of the solvent at the drying disappear and the filling ratio of ferromagnetic powder in the magnetic layer is elevated. As a result, the obtained magnetic recording medium can have high electromagnetic conversion characteristics. In this calendaring step, it is preferable to perform the calendaring treatment while altering the conditions depending on the surface smoothness of the coated master roll.

It is sometimes observed that the coated master roll shows a decrease in glossiness from the core side toward the outside of the wound roll, which causes variation in qualities in the longitudinal direction. It is known that glossiness correlates (being proportional) to surface roughness (Ra). When the calendaring treatment conditions (for example, calendar roll pressure) are not altered but maintained at a constant level during the calendaring treatment step, therefore, no countermeasure is taken against the difference in smoothness in the longitudinal direction that is caused by winding the coated master roll. In its turn, the final product also suffers from the variation in qualities in the longitudinal direction.

In the calendaring treatment step, therefore, it is preferable to alter the calendaring treatment conditions (for example, calendar roll pressure) to thereby compensate for the difference in smoothness in the longitudinal direction that is caused by winding the coated master roll. More specifically speaking, it is preferred that the calendar roll pressure is lowered from the core side toward the outside of the coated master roll having been unwound from the winding roll. According to the inventors' studies, it is found out that the glossiness is lowered (i.e., the smoothness is lowered) by lowering the calendar roll pressure. Thus, the difference in smoothness in the longitudinal direction that is caused by winding the coated master roll can be compensated and a final product free from variation in qualities in the longitudinal direction can be obtained.

Although the case where the calendar roll pressure is altered is described above, it is also possible to control the calendar roll temperature, the calendar roll speed or the calendar roll tension. By taking the characteristics of a coating vehicle into consideration, it is preferable to control the calendar roll pressure or the calendar roll temperature. By lowering the calendar roll pressure or lowering the calendar roll temperature, the surface smoothness of the final product is lowered. By elevating the calendar roll pressure or elevating the calendar roll temperature, on the contrary, the surface smoothness of the final product is elevated.

Separately, heat curing can be promoted by thermally treating the magnetic recording medium obtained after the calendaring treatment. An appropriate thermal treatment may be determined depending on the formulation of a coating composition for magnetic layer. For example, it can be performed at 35 to 100° C., preferably 50 to 80° C. The thermal treatment is conducted for 12 to 72 hours, preferably 24 to 48 hours.

As the calendar roll, use may be made of a thermostable plastic roll made of epoxy, polyimide, polyamide, polyamideimide, etc. It is also possible to perform the treatment using a metallic roll.

It is preferable that the surface of the magnetic recording medium of the invention has an extremely high smoothness as having a center-plane average surface roughness of 0.1 to 4 nm, preferably 1 to 3 nm (at cutoff value 0.25 mm). The calendaring treatment conditions to be employed for achieving such a high surface smoothness are as follows. Namely, the calendar roll temperature is controlled to from 60 to 100° C., preferably from 70 to 100° C. and particularly preferably from 80 to 100° C.; the pressure is controlled to from 100 to 500 kg/cm (98 to 490 kN/m), preferably from 200 to 450 kg/cm (196 to 441 kN/m) and particularly preferably from 300 to 400 kg/cm (294 to 392 kN/m).

The magnetic recording medium thus obtained can be cut into a desired size with a cutter, etc. before using. Although the cutter is not particularly restricted, it is preferable to employ a cutter provided with multiple pairs of a rotating upper blade (a male blade) and a lower blade (a female blade). The slit speed, the engagement depth, the peripheral velocity ratio of the upper blade (male blade) to the lower blade (female blade), the time of continuously using the slit blades, etc. may be appropriately selected.

[Physical Properties]

The saturation magnetic flux density of the magnetic layer of the magnetic recording medium according to the present invention is preferably from 100 to 400 mT. The antimagnetic force (Hc) of the magnetic layer is preferably from 143.2 to 318.3 kA/m ((1800 to 4000 Oe), more preferably from 159.2 to 278.5 kA/m (2000 to 3500 Oe). Antimagnetic force distribution is preferably narrow, and SFD and SFDr are preferably 0.6 or less, more preferably 0.3 or less.

The magnetic recording medium in the present invention has a friction coefficient against a head at temperature of from −10° C. to 40° C. and humidity of from 0% to 95% of 0.50 or less, preferably 0.3 or less. The surface inherent resistivity of the magnetic surface thereof is preferably from 10⁴ to 10⁸ Ω/sq. The charge potential thereof is preferably from −500 V to +500 V. The elastic modulus at 0.5% elongation of the magnetic layer is preferably from 0.98 to 19.6 GPa (100 to 2000 kg/mm²) in every direction of in-plane. The breaking strength thereof is preferably from 98 to 686 MPa (10 to 70 kg/cm²). The elastic modulus of the magnetic recording medium is preferably from 0.98 to 14.7 GPa (100 to 1,500 kg/mm²) in every direction of in-plane. The residual elongation thereof is preferably 0.5% or less. The thermal shrinkage factor thereof at every temperature not exceeding 100° C. is preferably 1% or less, more preferably 0.5% or less, and most preferably 0.1% or less.

The glass transition temperature of the magnetic layer (the maximum of loss elastic modulus by dynamic viscoelasticity measurement at 110 Hz) is preferably from 50° C. to 180° C., and that of the nonmagnetic layer is preferably from 0° C. to 180° C. The loss elastic modulus is preferably within the range of from 1×10⁷ to 8×10⁸ Pa (1×10⁸ to 8×10⁹ dyne/cm²), and loss tangent is preferably 0.2 or less. If loss tangent is too great, adhesion failure is liable to occur. These thermal and mechanical characteristics are preferably almost equal in every direction of in-plane of the medium within difference of 10% or less.

The amount of the residual solvent in the magnetic layer is preferably 100 mg/m² or less, more preferably 10 mg/m² or less. The void ratio of each coating layer is preferably 30% by volume or less, more preferably 20% by volume or less, with both of the nonmagnetic layer and the magnetic layer. The void ratio is preferably smaller for obtaining high output but in some cases a specific value should be preferably secured depending upon purposes. For example, in a disc-like medium which is repeatedly used, for example, large void ratio contributes to good running durability in many cases.

The magnetic layer preferably has an average surface roughness (Ra) of 3 nm or less and a ten point average roughness (Rz) of 30 nm or less. These factors can be easily controlled by controlling the surface properties by fillers in the support or varying the surface shape of rollers used in the calendaring treatment. Curling is preferably within the range of ±3 mm.

In the magnetic recording medium according to the present invention, these physical properties of the nonmagnetic layer and the magnetic layer can be varied according to purposes. For example, the elastic modulus of the magnetic layer is made higher to improve running durability and at the same time the elastic modulus of the nonmagnetic layer is made lower than that of the magnetic layer to improve the head touching of the magnetic recording medium.

[Method of Magnetic Record Reproduction]

In the reproduction method of the magnetic recording medium according to the invention, it is preferable to reproduce a signal magnetically recorded at a maximum linear recording density of 200 KFCI or more by using an MR head.

An MR head, in which the magneto-resistance effect responding to the flux of a thin film magnetic head is utilized, has an advantage of achieving a much higher output compared with the conventional induction type heads. This is mainly because the reproduction output of an MR head depends not on the relative velocity of the disk and head but on a change in magneto-resistance and a higher output can be achieved compared with the conventional induction type heads. Use of such an MR head as a reproduction head, excellent reproduction characteristics can be obtained in the high-frequency region.

In the case where the magnetic recording medium of the invention is a tape-shaped magnetic recording medium, even a signal recorded in a higher frequency region compared with the conventional ones can be reproduced at a high C/N ratio by using an MR head as a reproduction head. Thus, the magnetic recording medium of the invention is highly suitable for magnetic tapes and magnetic recording disks for high-density recording computer data.

### EXAMPLES

Next, the present invention will be described in greater detail by referring to the following Examples. It is to be understood that various changes in the components, proportions, operations, orders, etc. can be made without departing from the spirit of the invention and the invention is not construed as being restricted to the following Examples. Unless otherwise noted, every “part” given in Examples are by mass.

### Example 1-1

### 1. Preparation of Coating Solution for Magnetic Layer

| | | |
|---|---|---|
| Ferromagnetic hexagonal ferrite powder | 100 | parts |
| Composition (molar ratio): Ba/Fe/Co/Zn = 1/9/0.2/0/8 | | |
| Average tabular diameter: 30 nm | | |
| Average tabular ratio: 3 | | |
| Specific surface area (BET): 50 m²/g | | |
| Antimagnetic force (Hc): 191 kA/m | | |
| Saturation magnetization (σs): 60 A m²/kg | | |
| Polyurethane resin | 11 | parts |
| Branched side chain-containing polyester polyol/ | | |
| dipehnylmethane diisocyanate-based | | |
| Hydrophilic polar group content: —SO₃Na = 70 eq/ton | | |
| Vinyl chloride-based resin | 7 | parts |
| (MR104 manufactured by ZEON Co.) | | |
| Phenylphosphonic acid | 3 | parts |
| α-Al₂O₃ (average particle size 0.15 μm) | 2 | parts |
| Cyclohexanone | 110 | parts |
| Methyl ethyl ketone | 100 | parts |
| Toluene | 100 | parts |
| Butyl stearate | 2 | parts |
| Stearic acid | 1 | part |

### 2. Preparation of Coating Solution for Nonmagnetic Layer and Backcoat Layer

| | | |
|---|---|---|
| Nonmagnetic inorganic powder | 85 | parts |
| α-iron oxide, surface-treated layer: Al₂O₃, SiO₂ | | |
| Average major axis diameter: 0.10 μm | | |
| Acicular ratio: 6 | | |
| Specific surface area (BET): 50 m²/g | | |
| DBP oil absorption: 33 ml/100 g | | |
| pH: 8 | | |
| Carbon black | 20 | parts |
| Specific surface area (BET): 250 m²/g | | |
| DBP oil absorption: 120 ml/100 g | | |
| pH: 8 | | |
| Volatile matter content: 1.5% | | |
| Polyurethane resin | 18 | parts |
| Polyether polyol/dipehnylmethane diisocyanate-based | | |
| Hydrophilic polar group content: —SO₃Na = 70 eq/ton | | |
| Vinyl chloride-based resin | 2 | parts |
| (MR104 manufactured by ZEON Co.) | | |
| Phenylphosphonic acid | 3 | parts |
| α-Al₂O₃ (average particle size 0.2 μm) | 1 | part |
| Cyclohexanone | 140 | parts |
| Methyl ethyl ketone | 170 | parts |
| Toluene | 100 | parts |
| Butyl stearate | 2 | parts |
| Stearic acid | 1 | part |

The components of each of the coating solutions as specified above were kneaded in an open kneader for 60 minutes and then dispersed with a sand mill for 120 minutes. To the dispersion thus obtained, 6 parts of a trifunctional low-molecular weight polyisocyanate compound (Colonate 3041; manufactured by Nippon Polyurethane Industry Co., Ltd.) was added and mixing was continued by stirring for additional 20 minutes. Next, the mixture was filtered through a filter having an average pore size of 1 μm, thereby giving coating solutions respectively for magnetic layer, nonmagnetic layer and backcoat layer.

As a support, use was made of a polyethylene naphthalate (PEN) support having an average surface roughness (Ra) at the center of 1.0 nm and a thickness of 5.0 μm. The coating solution for nonmagnetic layer as described above was applied thereto to give a layer thickness after drying of 1.4 μm. Immediately thereafter, the coating solution for magnetic layer was overlaid thereon to give a layer thickness after drying of 0.15 μm. While these layers were still in the moist state, a magnetic field orientation with a magnet having 300 mT was conducted followed by drying. Next, the coating solution for backcoat layer as described above was applied to the face of the nonmagnetic support opposite to the face having the nonmagnetic layer and the magnetic layer formed thereon so as to give a backcoat layer thickness after drying and calendaring of 0.6 μm and then dried. Subsequently, calendaring was conducted by using a 7-stage calendar at a temperature of 90° C. and a calendaring speed of 100 m/min and under a linear pressure of 300 kg/cm (294 kN/m). After heating at 70° C. for 48 hours, the product was slitted in a ½ in. width to give a magnetic tape.

### Example 1-2

A magnetic tape was produced as in Example 1-1 but changing the SP value and glass transition temperature of the polyurethane resin in the coating solution for backcoat layer as shown in Table 1 and further changing the composition ratio of the vinyl chloride-based resin to the polyurethane resin and the glass transition temperature of the backcoat layer as shown in Table 1.

### Example 1-3

A magnetic tape was produced as in Example 1-1 but changing the SP value and glass transition temperature of the polyurethane resin in the coating solution for backcoat layer as shown in Table 1 and further changing the composition ratio of the vinyl chloride-based resin to the polyurethane resin and the glass transition temperature of the backcoat layer as shown in Table 1.

### Example 2-1

A magnetic tape was produced as in Example 1-1 but changing the SP value and glass transition temperature of the polyurethane resin in the coating solution for backcoat layer as shown in Table 1, further changing the composition ratio of the vinyl chloride-based resin to the polyurethane resin and the glass transition temperature of the backcoat layer as shown in Table 1, and further using the following ferromagnetic acicular metal powder (Fe alloy) having an average major axis length of 45 nm as the magnetic powder employed in the magnetic layer.

Composition: Fe/Co/Al/Y=67/20/8/5

Surface-treatment agent: Al₂O₃, Y₂O₃

Antimagnetic force (Hc): 185 kA/m

Crystalline size: 12 nm

Major axis diameter: 45 nm

Acicular ratio: 5.8

Specific surface area (BET): 46 m²/g

Saturation magnetization (σs): 140 A m²/kg (140 emu/g)

### Example 3-1

A magnetic tape was produced as in Example 1-1 but changing the SP value and glass transition temperature of the polyurethane resin in the coating solution for backcoat layer as shown in Table 1, further changing the composition ratio of the vinyl chloride-based resin to the polyurethane resin and the glass transition temperature of the backcoat layer as shown in Table 1, and further using a ferromagnetic iron nitride powder having an average particle diameter of 10 nm as the magnetic powder employed in the magnetic layer.

### Comparative Example 1-1

A magnetic tape was produced as in Example 1-1 but changing the molecular weight and glass transition temperature of the vinyl chloride-based resin in the coating solution for backcoat layer as shown in Table 1, changing the SP value and glass transition temperature of the polyurethane resin as shown in Table 1, and further changing the composition ratio of the vinyl chloride-based resin to the polyurethane resin and the glass transition temperature of the backcoat layer as shown in Table 1.

### Comparative Example 1-2

A magnetic tape was produced as in Example 1-1 but changing the SP value and glass transition temperature of the polyurethane resin in the coating solution for backcoat layer as shown in Table 1, and further changing the composition ratio of the vinyl chloride-based resin to the polyurethane resin and the glass transition temperature of the backcoat layer as shown in Table 1.

### Comparative Example 1-3

A magnetic tape was produced as in Example 1-1 but changing the composition of the coating solution for backcoat layer as shown below. The coating solution for backcoat layer was prepared by dispersing the following components in a sand mill for a retention time of 45 minutes, then adding 8.5 parts of polyisocyanate and then stirring and filtering the resultant mixture.

Coating Solution for Backcoat Layer

| | | |
|---|---|---|
| Carbon black (average particle diameter: 25 nm) | 40.5 | parts |
| Barium sulfate | 4.05 | parts |
| Nitrocellulose | 40 | parts |
| Vinyl chloride-based resin | 10 | parts |
| (MR104: manufactured by ZEON Corporation) | | |
| Cyclohexanone | 100 | parts |
| Toluene | 100 | parts |
| Methyl ethyl ketone | 100 | parts |

### Comparative Example 2-1

A magnetic tape was produced as in Example 1-1 but changing the molecular weight and glass transition temperature of the vinyl chloride-based resin in the coating solution for backcoat layer as shown in Table 1, changing the SP value and glass transition temperature of the polyurethane resin as shown in Table 1, further changing the composition ratio of the vinyl chloride-based resin to the polyurethane resin and the glass transition temperature of the backcoat layer as shown in Table 1, and further using a ferromagnetic acicular metal powder having an average major axis length of 45 nm as the magnetic powder employed in the magnetic layer.

### Comparative Example 3-1

A magnetic tape was produced as in Example 1-1 but changing the molecular weight and glass transition temperature of the vinyl chloride-based resin in the coating solution for backcoat layer as shown in Table 1, changing the SP value and glass transition temperature of the polyurethane resin as shown in Table 1, further changing the composition ratio of the vinyl chloride-based resin to the polyurethane resin and the glass transition temperature of the backcoat layer as shown in Table 1, and further using a ferromagnetic iron nitride-based powder having an average particle diameter of 10 nm as the magnetic powder employed in the magnetic layer.

The magnetic tapes as described above were evaluated by using the following measurement methods.

### 1. Measurement of SP Value

The SP value of a binder was determined by mixing a solvent having a known SP value singly or as a mixture and referring the value at which the maximum solubility was established to as the SP value of the binder.

### 2. Measurement of Glass Transition Temperature (Tg)

By using Rheovibron (manufactured by Toyo Baldwin Co. Ltd.), the temperature-dependency of dynamic viscoelasticity was measured at a vibration frequency of 110 Hz and a temperature-rising speed of 3° C./min. The peak of the E″ temperature-dependency curve thus obtained was defined as Tg.

### 3. Measurement of Weight-Average Molecular Weight

By using Gel Permeation Chromatography HLC-8020 (manufactured by TOSOH Corporation), a calibration curve was measured with the use of tetrahydrofuran as an eluent and standard polystyrene. Thus, the weight-average molecular weight (standard: polystyrene) was determined.

### 4. Measurement of Error Rates

### Initial Stage and at High Temperature/High Humidity

Recording signals were recorded at 23° C. and 50% RH by the 8-10 conversion PR1 equalization system and stored at 23° C. and 50% R^{H} (the initial stage) and at 50° C. and 80% R^{H} each for 1 week followed by the measurement.

Table 1 summarizes the results.

TABLE 1

| | | | Back coat | | | | | | | | | | |
|---|---|---|---|---|---|---|---|---|---|---|---|---|---|
| | Nonmagnetic | | | | | | | | | | | PVc/PU | |
| | support | | Vinyl chloride-based resin | | | Polyurethane resin | | | NC | | | ratio | |
| | | Thickness | SP value | Tg | | SP value | Tg | | SP value | Tg | | % by | Tg*¹ |
| No. | Material | μm | (cal · cm⁻³)^{1/2} | ° C. | Mw | (cal · cm⁻³)^{1/2} | ° C. | Mw | (cal · cm⁻³)^{1/2} | ° C. | Mw | mass | ° C. |
| Ex. 1-1 | PEN | 5.0 | 9.7 | 73 | 15000 | 11.4 | 95 | 40000 | — | — | — | 10/90 | 90 |
| Ex. 1-2 | PEN | 5.0 | 9.7 | 73 | 15000 | 11.3 | 90 | 40000 | — | — | — | 30/70 | 85 |
| Ex. 1-3 | PEN | 5.0 | 9.7 | 73 | 15000 | 11.2 | 80 | 40000 | — | — | — | 50/50 | 80 |
| Ex. 2-1 | PEN | 5.0 | 9.7 | 73 | 15000 | 11.3 | 90 | 40000 | — | — | — | 30/70 | 80 |
| Ex. 3-1 | PEN | 5.0 | 9.7 | 73 | 15000 | 11.3 | 90 | 40000 | — | — | — | 30/70 | 80 |
| C. Ex. 1-1 | PEN | 5.0 | 9.7 | 70 | 30000 | 11.3 | 90 | 40000 | — | — | — | 30/70 | 85 |
| C. Ex. 1-2 | PEN | 5.0 | 9.7 | 73 | 15000 | 9.6 | 60 | 40000 | — | — | — | 30/70 | 60 |
| C. Ex. 1-3 | PEN | 5.0 | 9.7 | 73 | 15000 | — | — | — | 11.9 | 180 | 40000 | — | 120 |
| C. Ex. 2-1 | PEN | 5.0 | 9.7 | 70 | 30000 | 9.6 | 60 | 40000 | — | — | — | 30/70 | 60 |
| C. Ex. 3-1 | PEN | 5.0 | 9.7 | 70 | 30000 | 9.6 | 60 | 40000 | — | — | — | 30/70 | 60 |

Magnetic material

| | |
|---|---|
| Particle | Error rate |

| | | diameter | | 50° C. |
|---|---|---|---|---|
| No. | Kind | nm | Initial ×10⁻⁵ | 80% RH ×10⁻⁵ |
| Ex. 1-1 | Ba ferrite | 25 | 0.17 | 1.29 |
| Ex. 1-2 | Ba ferrite | 25 | 0.16 | 1.17 |
| Ex. 1-3 | Ba ferrite | 25 | 0.13 | 0.96 |
| Ex. 2-1 | Fe alloy | 45 | 0.18 | 1.55 |
| Ex. 3-1 | Fe nitride | 10 | 0.15 | 1.18 |
| C. Ex. 1-1 | Ba ferrite | 25 | 0.39 | 9.87 |
| C. Ex. 1-2 | Ba ferrite | 25 | 0.84 | 5.36 |
| C. Ex. 1-3 | Ba ferrite | 25 | 0.84 | 5.36 |
| C. Ex. 2-1 | Fe alloy | 45 | 0.35 | 11.69 |
| C. Ex. 3-1 | Fe nitride | 10 | 0.26 | 8.99 |

Ex.: Example, C. EX.: Comparative Example

In Table 1, each symbol has the following meaning.

NC: nitrocellulose

SP value: solubility parameter

Tg: glass transition temperature

Mw: weight-average molecular weight (standard: polystyrene)

PVC/PU ratio: ratio of vinyl chloride-based resin/polyurethane resin (vinyl chloride-based resin+polyurethane resin=100)

Particle diameter: Ba ferrite: average tabular diameter

Fe alloy: average major axis length
iron nitride: average particle diameter
   Tg*¹ stands for the Tg of the backcoat layer.

Table 1 indicates that the magnetic recording media having a backcoat layer with a glass transition temperature of from 65 to 95° C. and having a binder constituting the backcoat layer satisfying all of the requirements (1) to (5) as defined in the present invention can provide improved error rates. That is to say, the glass transition temperature of the backcoat layer and the kind and physical properties of a binder are specified in the present invention, which makes it possible to provide a magnetic recording medium being little affected by temperature/humidity or tension in the drive, having a high dimensional stability and a high mechanical strength, thus achieving excellent electromagnetic conversion characteristics and a high running stability, maintaining a high S/N ratio, showing reduced dropout and having a low error rate.

According to the invention, the glass transition temperature of the backcoat layer and the kind and the physical properties of the binder thereof are specified, which makes it possible to provide a magnetic recording medium being scarcely affected by temperature/humidity or tension in the drive, being excellent in dimensional stability and mechanical strength, thus having excellent electromagnetic conversion characteristics, achieving a high running stability, maintaining a high S/N ratio, showing reduced dropout and having a low error rate.

The entire disclosure of each and every foreign patent application from which the benefit of foreign priority has been claimed in the present application is incorporated herein by reference, as if fully set forth.

What is claimed is:

1. A magnetic recording medium, which comprises:
a backcoat layer comprising a first binder;
a nonmagnetic support;
a nonmagnetic layer comprising a nonmagnetic powder and a second binder; and
a magnetic layer comprising a ferromagnetic powder and a third binder, in this order,
wherein the backcoat layer has a glass transition temperature of from 65 to 95° C., and
the first binder satisfies all of the following requirements (1) to (5):
(1) the first binder comprises a vinyl chloride-based resin and a polyurethane resin as main components;
(2) the vinyl chloride-based resin has a solubility parameter of from 9 to 11 (cal·cm⁻³)^{1/2}, a glass transition temperature of from 65 to 95° C. and a weight-average molecular weight of from 5000 to 25000;
(3) a ratio of the vinyl chloride-based resin to the total mass of the vinyl chloride-based resin and the polyurethane resin is from 10 to 60% by mass;
(4) the polyurethane resin has a solubility parameter of from 9.5 to 11.5 (cal·cm⁻³)^{1/2}, a glass transition temperature of from 80 to 110° C. and a weight-average molecular weight of from 20000 to 60000; and
(5) a ratio of the polyurethane resin to the total mass of the vinyl chloride-based resin and the polyurethane resin is from 90 to 30% by mass.

2. The magnetic recording medium according to claim 1,
wherein the ferromagnetic powder is a ferromagnetic hexagonal ferrite powder having an average tabular diameter of from 10 to 50 nm, an iron nitride powder having an average particle diameter of from 5 to 25 nm or a ferromagnetic metal powder having an average major axis length of from 10 to 100 nm.

3. The magnetic recording medium according to claim 1,
wherein the backcoat layer further comprises at least one of a carbon black and an inorganic powder.

4. The magnetic recording medium according to claim 1,
wherein the backcoat layer has a thickness of from 0.1 to 1.0 μm.

5. The magnetic recording medium according to claim 1,
wherein the backcoat layer has a glass transition temperature of from 70 to 90° C.

6. The magnetic recording medium according to claim 1,
wherein the vinyl chloride-based resin has a solubility parameter of from 9.5 to 10.5 (cal·cm⁻¹)^{1/2}.

7. The magnetic recording medium according to claim 1,
wherein the vinyl chloride-based resin has a glass transition temperature of from 70 to 90° C.

8. The magnetic recording medium according to claim 1,
wherein the vinyl chloride-based resin has a weight-average molecular weight of from 10000 to 20000.

9. The magnetic recording medium according to claim 1,
wherein the polyurethane resin has a solubility parameter of from 10.0 to 11.0 (cal·cm⁻³)^{1/2}.

10. The magnetic recording medium according to claim 1,
wherein the polyurethane resin has a glass transition temperature of from 80 to 95° C.

11. The magnetic recording medium according to claim 1,
wherein the vinyl chloride-based resin contains at least one of: from 2 to 7 eq/ton of at least one polar group selected from the group consisting of —SO₃M, —OSO₃M, —PO(OM)₂, —OPO(OM)₂ and —COOM, wherein M represents a hydrogen atom, an alkaline metal or an ammonium salt; and from 5 to 50 eq/ton of at least one polar group selected from the group consisting of —CONR₁R₂, —NR₁R₂ and —NR₁R₂R₃⁺, wherein R₁, R₂ and R₃ each independently represents a hydrogen atom or an alkyl group.

12. The magnetic recording medium according to claim 1,
wherein the polyurethane resin contains at least one of: from 2 to 7 eq/ton of at least one polar group selected from the group consisting of —SO₃M, —OSO₃M, —PO(OM)₂, —OPO(OM)₂ and —COOM, wherein M represents a hydrogen atom, an alkaline metal or an ammonium salt; and from 5 to 50 eq/ton of at least one polar group selected from the group consisting of —CONR₁R₂, —NR₁R₂ and —NR₁R₂R₃⁺, wherein R₁, R₂ and R₃ each independently represents a hydrogen atom or an alkyl group.

13. The magnetic recording medium according to claim 1,
wherein the polyurethane resin contains 2 to 40 OH— groups per molecule.
